(19) United States
(12) Patent Application Publication
(10) Pub. No.: US 2012/0315609 A1
(43) Pub. Date: Dec. 13, 2012

(54) METHODS AND SYSTEMS FOR WEIGHT CONTROL BY UTILIZING VISUAL TRACKING OF LIVING FACTOR(S)

(75) Inventors: Karen Miller-Kovach, Charleston, SC (US); Ute Gerwig, Duesseldorf (DE)

(73) Assignee: Weight Watchers International, Inc., New York, NY (US)

(21) Appl. No.: 13/529,275

(22) Filed: Jun. 21, 2012

Related U.S. Application Data
(63) Continuation of application No. 13/493,845, filed on Jun. 11, 2012.
(60) Provisional application No. 61/495,630, filed on Jun. 10, 2011.

(51) Int. Cl. G09B 19/00

(52) U.S. Cl. 434/127

(57) ABSTRACT

A non-therapeutic method for assisting a person to control weight of the person that includes receiving, by a programmed computer system, input data, calculating, in real-time, by the programmed computer system, at least one actual RCV(t) value over a period of time based, at least in part, on the food data of the input data and stored food data; calculating, in real-time, by the programmed computer system, at least one potential RCV(t) value over a period of time; displaying, in real-time, by the programmed computer system, at least one first graphical indicator representative of the at least one actual RCV(t) value over the period of time; and displaying, in real-time, by the programmed computer system, at least one second graphical indicator representative of the at least one potential RCV(t) value over the period of time.

### RELATED APPLICATIONS

This application claims the priority of provisional application Ser. No. 61/495,630, filed Jun. 10, 2011, entitled “METHODS AND A SYSTEM FOR VISUAL TRACKING PERSON'S LIVING FACTOR(S) TO MAINTAIN WEIGHT CONTROL,” which is incorporated herein by reference in its entirety for all purposes.

### TECHNICAL FIELD

In some embodiments, the instant invention relates to methods and systems for a non-therapeutic weight control of a person.

### BACKGROUND

Consumers are striving to control their body weight, whether for the object of losing or gaining weight, or simply to maintain the weight they have, they are also eager to ensure that they are eating healthfully.

### SUMMARY OF INVENTION

In some embodiments, the instant invention is a non-therapeutic method for assisting a person to control weight of the person that can include receiving, by a programmed computer system, input data, where the input data comprises at least one of the following categories of data:

i) food data representative of at least one first food consumed by the person, and

ii) what-if food data representative of at least one second food that the person considers to consume.

In some embodiments, the method may further include calculating, in real-time, by the programmed computer system, at least one actual RCV(t) value over a period of time based, at least in part, on the food data of the input data and stored food data, where the stored food data is data about one or more food consumed by the person over the period of time prior to the receipt of the input data; calculating, in real-time, by the programmed computer system, at least one potential RCV(t) value over a period of time based, at least in part, on the what-if food data of the input data and the stored food data; displaying, in real-time, by the programmed computer system, at least one first graphical indicator representative of the at least one actual RCV(t) value over the period of time, where the displaying of at least one first graphical indicator is indicative of:

i) whether the at least one actual RCV(t) value over the period of time deviates from a visual representation of a pre-determined optimum value or a pre-determined optimum range of values, and

ii) an actual deviation if the at least one actual RCV(t) value over the period of time actually deviates from a visual representation of the pre-determined optimum value or the pre-determined optimum range of values, and where the displaying of at least one first graphical indicator provides information that assists the person to control the weight of the person.

In some embodiments, the method may further include displaying, in real-time, by the programmed computer system, at least one second graphical indicator representative of the at least one potential RCV(t) value over the period of time, where the displaying of at least one second graphical indicator is indicative of:

i) whether the at least one potential RCV(t) value over the period of time deviates from the visual representation of the pre-determined optimum value or the pre-determined optimum range of values and

ii) a potential deviation if the at least one potential RCV(t) value over the period of time actually deviates from the visual representation of the pre-determined optimum value or the pre-determined optimum range of values, and where the displaying of at least one second graphical indicator provides the information that assists the person to control the weight of the person.

In some embodiments, the non-therapeutic method includes displaying of the at least one first graphical indicator that includes positioning the at least one first graphical indicator at a first position along a scale, where the first position corresponds to the calculated at least one actual RCV(t) value over the period of time; where the displaying of the at least one second graphical indicator includes positioning the at least one second graphical indicator at a second position along the scale, where the second position corresponds to the calculated at least one potential RCV(t) value over the period of time; and where the visual representation of the pre-determined optimum value or the pre-determined optimum range of values is positioned at a third position along the scale.

In some embodiments, the at least one actual RCV(t) value is at least one actual RCAV(t) value and where the at least one potential RCV(t) value is at least one potential RCAV(t) value.

In some embodiments, the at least one actual RCAV(t) value is calculated based at least in part on the energy density of: (i) the food data of the input data and (ii) the stored food data, where the at least one potential RCAV(t) value over the period of time is calculated based at least in part on energy density of: (i) the what-if data of the input data and (ii) the stored food data, where the pre-determined optimum value or the pre-determined optimum range of values are determined from an energy density range of 0.5-1.6 kcal/gram.

In some embodiments, the at least one actual RCAV(t) value over the period of time is equal to:

(((amount of [kcal]of the at least one first food/100 gram)×weight of the at least one first food)+((amount of [kcal]of Food(2)of the stored food data/100 gram)×weight of consumed Food(2)of the stored food data)+ . . . +((amount of [kcal]of Food(n)of the stored food data/100 gram)×weight of consumed Food(n)of the stored food data))/(weight of the at least one first food+weight of consumed Food(2)of the stored food data+ . . . +weight of consumed Food(n)of the stored food data),

where “n” is the total number of Foods of the stored food data; where the at least one first food excludes non-dairy beverages; where the at least one potential RCAV(t) value is equal to:

(((amount of [kcal]of the at least one second food/100 gram)×weight of the at least one second food)+((amount of [kcal]of Food(2)of the stored food data/100 gram)×weight of consumed Food(2)of the stored food data)+ . . . +((amount of [kcal]of Food(n)of the stored food data/100 gram)×weight of consumed Food(n)of the stored food data))/(weight of the at least one second food+weight of consumed Food(2)of the stored food data+ . . . +weight of consumed Food(n)of the stored food data);

and where the at least one second food excludes non-dairy beverages.

In some embodiments, the present invention is a non-therapeutic method where the energy density range is 0.8-1.2 kcal/gram. In some embodiments, the energy density range is 1-1.25 kcal/gram

In some embodiments, the non-therapeutic method further includes receiving, by the programmed computer system, weight data of the person, and displaying, by the programmed computer system, at least one second graphical indicator based at least in part on determining, by the programmed computer system, that the person maintains the weight or the person loses weight.

In some embodiments, a first part of the input data is received from the person and a second part of the input data received from a source other than the person. In some embodiments, the source is a remote database.

In some embodiments, the at least one actual RCV(t) value over the period of time is calculated by:

obtaining weight of protein, PRO(m), for the food data of the input data; obtaining weight of fat, FAT(m), for the food data of the input data; obtaining weight of non-dietary fiber carbohydrates, CHO(m), for the food data of the input data; obtaining weight of dietary fiber, DF(m), for the food data of the input data; determining a whole number value for the food data of the input data by:

1) determining food energy data for the food data of the input data, FED value, based at least in part on one of:

i) W(PRO)×Cp×PRO(m), wherein W(PRO) is a metabolic efficiency factor of protein and wherein Cp is a energy conversion factor of protein,

ii) W(FAT)×Cf×FAT(m), wherein W(FAT) is a metabolic efficiency factor of fat and wherein Cf is a energy conversion factor of fat,

iii) W(CHO)×Cc×CHO(m), wherein W(CHO) is a metabolic efficiency factor of carbohydrate and wherein Cc is a energy conversion factor of carbohydrate, and

iv) W(DF)×Cdf×DF(m), wherein W(DF) is a metabolic efficiency factor of dietary fiber and wherein Cdf is a energy conversion factor of dietary fiber;

2) dividing the determined FED value by a factor data obtained from a storage device and saving the result as whole number value for the food data of the input data; determining a daily whole number benchmark data for the person; determining the food data of the input data's whole number value; summing, over the period of time, whole number values of the food data of the input data and the stored food data.

In some embodiments, W (PRO) is selected from a range 0.7<=W(PRO)<=0.9, W(CHO) is selected from a range 0.9<=W(CHO)<=0.99, W(FAT) is selected from a range 0.9<=W(FAT)<=1.0 and W(DF) is selected from a range 0<=W(DF)<=0.5.

In some embodiments, W (PRO) is selected from a range 0.75<=W(PRO)<=0.88. W(CHO) is selected from a range 0.92<=W(CHO)<=0.97, W (FAT) is selected from a range 0.95<=W(FAT)<=1.0 and W(DF) is selected from a range 0<=W(DF)<=0.25, wherein PRO(m), CHO(m), FAT(m) and DF(m) are expressed in grams, and where Cp is selected as 4 kilocalories/gram, Cc is selected as 4 kilocalories/gram, Cf is selected as 9 kilocalories/gram and Cdf is selected as 4 kilocalories/gram. In some embodiments, the factor data is a whole number selected from a range between 20 and 100.

In some embodiments, the at least one actual RCV(t) value over the period of time is based on: calculating p value for the food data of the input data by the following equation:

$$p = \frac{c}{{k}_{1}} + \frac{f}{{k}_{2}} - \frac{r}{{k}_{3}} ,$$

where c is calories, f is fat in grams and r is dietary fiber in grams for each candidate food serving and where k₁ is about 50, k₂ is about 12 and k₃ is about 5;

calculating P_{A} value for the person by the following equation:

$${P}_{A} = \frac{{k}_{4} \times kg body weight \times minutes of activity}{100} ,$$

where k₄ is a pre-determined numerical weighting factor determined on the basis of intensity level of physical exercise; and adding P_{A} to p when P_{A} exceeds a pre-determined threshold value.

In some embodiments, the at least one first graphical indicator, the at least one second graphical indicator, the visual representation of the pre-determined optimum value or the pre-determined optimum range of values, and the scale are displayed on a portable computing device of the person.

In some embodiments, the present invention includes a programmed computing device, including a non-transient memory having at least one region for storing computer executable program code; and at least one processor for executing the program code stored in the non-transient memory, wherein the program code includes code to receive input data, where the input data comprises at least one of the following categories of data:

i) food data representative of at least one first food consumed by the person, and

ii) what-if food data representative of at least one second food that the person considers to consume;

code to calculate, in real-time, at least one actual RCV(t) value over a period of time based, at least in part, on the food data of the input data and stored food data, where the stored food data is data about one or more food consumed by the person over the period of time prior to the receipt of the input data; code to calculate, in real-time, at least one potential RCV(t) value over a period of time based, at least in part, on the what-if food data of the input data and the stored food data; code to display, in real-time, at least one first graphical indicator representative of the at least one actual RCV(t) value over the period of time,

where the displaying of at least one first graphical indicator is indicative of:

i) whether the at least one actual RCV(t) value over the period of time deviates from a visual representation of a pre-determined optimum value or a pre-determined optimum range of values, and

ii) an actual deviation if the at least one actual RCV(t) value over the period of time actually deviates from a visual representation of the pre-determined optimum value or the pre-determined optimum range of values, and

where the displaying of at least one first graphical indicator provides information that assists the person to control the weight of the person; and code to display, in real-time, at least one second graphical indicator representative of the at least one potential RCV(t) value over the period of time,

where the displaying of at least one second graphical indicator is indicative of:

i) whether the at least one potential RCV(t) value over the period of time deviates from the visual representation of the pre-determined optimum value or the pre-determined optimum range of values and

ii) a potential deviation if the at least one potential RCV(t) value over the period of time actually deviates from the visual representation of the pre-determined optimum value or the pre-determined optimum range of values, and

where the displaying of at least one second graphical indicator provides the information that assists the person to control the weight of the person.

In some embodiments, the code to display the at least one first graphical indicator includes code to position the at least one first graphical indicator at a first position along a scale, where the first position corresponds to the calculated at least one actual RCV(t) value over the period of time; where the code to display the at least one second graphical indicator includes code to position the at least one second graphical indicator at a second position along the scale, wherein the second position corresponds to the calculated at least one potential RCV(t) value over the period of time; and where the visual representation of the pre-determined optimum value or the pre-determined optimum range of values is positioned at a third position along the scale.

In some embodiments, the at least one actual RCV(t) value is at least one actual RCAV(t) value and wherein the at least one potential RCV(t) value is at least one potential RCAV(t) value.

In some embodiments, the at least one actual RCAV(t) value is calculated based at least in part on energy density of: (i) the food data of the input data and (ii) the stored food data, where the at least one potential RCAV(t) value over the period of time is calculated based at least in part on energy density of: (i) the what-if data of the input data and (ii) the stored food data, where the pre-determined optimum value or the pre-determined optimum range of values are determined from an energy density range of 0.5-1.6 kcal/gram.

In some embodiments, the at least one actual RCAV(t) value over the period of time is equal to:

(((amount of [kcal]of the at least one first food/100 gram)×weight of the at least one first food)+((amount of [kcal]of Food(2)of the stored food data/100 gram)×weight of consumed Food(2)of the stored food data)+ . . . +((amount of [kcal]of Food(n)of the stored food data/100 gram)×weight of consumed Food(n)of the stored food data))/(weight of the at least one first food+weight of consumed Food(2)of the stored food data+ . . . +weight of consumed Food(n)of the stored food data),

wherein “n” is the total number of Foods of the stored food data;

where the at least one first food excludes non-dairy beverages; where the at least one potential RCAV(t) value is equal to:

(((amount of [kcal]of the at least one second food/100 gram)×weight of the at least one second food)+((amount of [kcal]of Food(2)of the stored food data/100 gram)×weight of consumed Food(2)of the stored food data)+ . . . +((amount of [kcal]of Food(n)of the stored food data/100 gram)×weight of consumed Food(n)of the stored food data))/(weight of the at least one second food+weight of consumed Food(2)of the stored food data+ . . . +weight of consumed Food(n)of the stored food data); and

where the at least one second food excludes non-dairy beverages.

In some embodiments, the energy density range is 0.8-1.2 kcal/gram. In some embodiments, the energy density range is 1-1.25 kcal/gram.

In some embodiments, the program code further includes code to receive weight data of the person, and code to display at least one second graphical indicator based at least in part on a determination that the person maintains the weight or the person loses weight.

In some embodiments, a first part of the input data is received from the person and a second part of the input data received from a source other than the person. In some embodiments, the source is a remote database.

In some embodiments, the code to calculate the at least one actual RCV(t) value over the period of time further includes code to obtain weight of protein, PRO(m), for the food data of the input data; code to obtain weight of fat, FAT(m), for the food data of the input data; code to obtain weight of non-dietary fiber carbohydrates, CHO(m), for the food data of the input data; code to obtain weight of dietary fiber, DF(m), for the food data of the input data; code to determine a whole number value for the food data of the input data, wherein the whole number value for the food data of the input data is determined by:

1) determining food energy data for the food data of the input data, FED value, based at least in part on one of:

i) W(PRO)×Cp×PRO(m), wherein W(PRO) is a metabolic efficiency factor of protein and wherein Cp is a energy conversion factor of protein,

ii) W(FAT)×Cf×FAT(m), wherein W(FAT) is a metabolic efficiency factor of fat and wherein Cf is a energy conversion factor of fat,

iii) W(CHO)×Cc×CHO(m), wherein W(CHO) is a metabolic efficiency factor of carbohydrate and wherein Cc is a energy conversion factor of carbohydrate, and

iv) W(DF)×Cdf×DF(m), wherein W(DF) is a metabolic efficiency factor of dietary fiber and wherein Cdf is a energy conversion factor of dietary fiber;

2) dividing the determined FED value by a factor data obtained from a storage device and saving the result as whole number value for the food data of the input data; code to determine a daily whole number benchmark data for the person; code to determine the food data of the input data's whole number value; code to sum, over the period of time, whole number values of the food data of the input data and the stored food data.

In some embodiments, W (PRO) is selected from a range 0.7<=W(PRO)<=0.9, W(CHO) is selected from a range 0.9<=W(CHO)<=0.99, W(FAT) is selected from a range 0.9<=W(FAT)<=1.0 and W(DF) is selected from a range 0<=W(DF)<=0.5. In some embodiments, W (PRO) is selected from a range 0.75<=W(PRO)<=0.88, W(CHO) is selected from a range 0.92<=W(CHO)<=0.97, W (FAT) is selected from a range 0.95<=W(FAT)<=1.0 and W(DF) is selected from a range 0<=W(DF)<=0.25, wherein PRO(m), CHO(m), FAT(m) and DF(m) are expressed in grams, and wherein Cp is selected as 4 kilocalories/gram, Cc is selected as 4 kilocalories/gram, Cf is selected as 9 kilocalories/gram and Cdf is selected as 4 kilocalories/gram.

In some embodiments, the at least one actual RCV(t) value over the period of time is based on:

calculating p value for the food data of the input data by the following equation:

$$p = \frac{c}{{k}_{1}} + \frac{f}{{k}_{2}} - \frac{r}{{k}_{3}} ,$$

where c is calories, f is fat in grams and r is dietary fiber in gams for each candidate food serving and where k₁ is about 50, k₂ is about 12 and k₃ is about 5;

calculating P_{A} value for the person by the following equation:

$${P}_{A} = \frac{{k}_{4} \times kg body weight \times minutes of activity}{100} ,$$

where k₄ is a pre-determined numerical weighting factor determined on the basis of intensity level of physical exercise; and adding P_{A} to p when P_{A} exceeds a pre-determined threshold value.

### BRIEF DESCRIPTION OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention. Further, some features may be exaggerated to show details of particular components.

FIG. 1 illustrates certain features of some embodiments of the present invention.

FIG. 2 illustrates certain features of some further embodiments of the present invention.

FIG. 3 illustrates certain features of some further embodiments of the present invention.

FIG. 4 illustrates certain features of some further embodiments of the present invention.

FIG. 5 illustrates certain features of some further embodiments of the present invention.

FIG. 6 illustrates certain features of some further embodiments of the present invention.

FIG. 7 illustrates certain features of some further embodiments of the present invention.

FIG. 8 illustrates yet certain features of some further embodiments of the present invention.

FIG. 9 illustrates yet certain features of some further embodiments of the present invention.

FIG. 10 illustrates yet certain features of some further embodiments of the present invention.

FIG. 11 illustrates yet certain features of some further embodiments of the present invention.

FIG. 12 illustrates yet certain features of some further embodiments of the present invention.

FIG. 13 illustrates yet certain features of some further embodiments of the present invention.

FIG. 14 illustrates yet certain features of some further embodiments of the present invention.

FIGS. 15A-15C illustrate yet certain features of some further embodiments of the present invention.

FIGS. 16A-16B illustrate yet certain features of some further embodiments of the present invention.

FIGS. 17A-17B illustrate yet certain features of some further embodiments of the present invention.

FIG. 18 illustrates yet certain features of some further embodiments of the present invention.

FIG. 19 illustrates yet certain features of some further embodiments of the present invention.

FIG. 20 illustrates yet certain features of some further embodiments of the present invention.

FIGS. 21A-21B illustrate yet certain features of some further embodiments of the present invention.

FIGS. 22A-22B illustrate yet certain features of some further embodiments of the present invention.

FIG. 23 illustrates yet certain features of some further embodiments of the present invention.

FIG. 24 illustrates yet certain features of some further embodiments of the present invention.

FIG. 25 illustrates yet certain features of some further embodiments of the present invention.

FIG. 26 illustrates yet certain features of some further embodiments of the present invention.

FIG. 27 illustrates yet certain features of some further embodiments of the present invention.

FIG. 28 illustrates yet certain features of some further embodiments of the present invention.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

### DETAILED DESCRIPTION

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

Throughout the specification and claims, the following terms take the meanings explicitly associated herein, unless the context clearly dictates otherwise. The phrases “In some embodiments” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

In some embodiments, the term “energy content” as used herein refers to the energy content of a given food, whether or not adjusted for the metabolic conversion efficiency of one or more nutrients in the food.

In some embodiments, the term “metabolic conversion efficiency” as used herein includes both absolute measures of metabolic conversion efficiency and the metabolic conversion efficiency of nutrients relative to each other.

In some embodiments, the term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. In some embodiments, the term “data” as used to represent pre-determined information in one physical non-transient form shall be deemed to encompass any and all representations of corresponding information in a different physical form or forms.

In some embodiments, the term “presentation data” as used herein means data to be presented to a person in any perceptible form, including but not limited to, visual form and aural form. Examples of presentation data include data displayed on a visual presentation device, such as a PDA, a smart phone, a monitor, and data printed on paper.

In some embodiments, the term “presentation device” as used herein means a device or devices capable of presenting data to a person in any perceptible form.

In some embodiments, the term “database” as used herein means an organized body of related data, regardless of the manner in which the data or the organized body thereof is represented. For example, the organized body of related data may be in the form of one or more of a table, a map, a grid, a packet, a datagram, a frame, a file, an e-mail, a message, a document, a list or in any other suitable form.

In some embodiments, the term “image dataset” as used herein means a database suitable for use as presentation data or for use in producing presentation data.

In some embodiments, the term “auxiliary image feature” as used herein means one or more of the color, brightness, shading, shape or texture of an image.

In some embodiments, the term “network” as used herein includes both networks and internetworks of all kinds, including the Internet, and is not limited to any particular network or inter-network. For example, “network” includes those that are implemented using wired links, wireless links or any combination of wired and wireless links.

In some embodiments, the terms “first”, “second”, “primary” and “secondary” are used to distinguish one element, set, data, object, step, process, activity or thing from another, and are not used to designate relative position or arrangement in time, unless otherwise stated explicitly.

In some embodiments, the terms “coupled”, “coupled to”, “coupled with,” “connected”, and “connected with” as used herein each mean a relationship between or among two or more devices, apparatus, files, circuits, elements, functions, operations, processes, programs, media, components, networks, systems, subsystems, and/or means, constituting any one or more of (a) a connection, whether direct or through one or more other devices, apparatus, files, circuits, elements, functions, operations, processes, programs, media, components, networks, systems, subsystems, or means, (b) a communication relationship, whether direct or through one or more other devices, apparatus, files, circuits, elements, functions, operations, processes, programs, media, components, networks, systems, subsystems, or means, and/or (c) a functional relationship in which the operation of any one or more devices, apparatus, files, circuits, elements, functions, operations, processes, programs, media, components, networks, systems, subsystems, or means depends, in whole or in part, on the operation of any one or more others thereof.

In some embodiments, the terms “communicate,” “communicating” and “communication” as used herein include both conveying data from a source to a destination, and delivering data to a communication medium, system, channel, network, device, wire, cable, fiber, circuit and/or link to be conveyed to a destination. The term “communications” as used herein includes one or more of a communication medium, system, channel, network, device, wire, cable, fiber, circuit and link.

In some embodiments, the term “processor” as used herein means processing devices, apparatus, programs, circuits, components, systems and subsystems, whether implemented in hardware, software or both, and whether or not programmable. In some embodiments, the term “processor” as used herein includes, but is not limited to one or more computers, hardwired circuits, neural networks, signal modifying devices and systems, devices and machines for controlling systems, central processing units, programmable devices and systems, field programmable gate arrays, application specific integrated circuits, systems on a chip, systems comprised of discrete elements and/or circuits, state machines, virtual machines, data processors, processing facilities and combinations of any of the foregoing.

In some embodiments, the term “data processing system” as used herein means a system implemented at least in part by hardware and comprising a data input device, a data output device and a processor coupled with the data input device to receive data therefrom and coupled with the output device to provide processed data thereto.

In some embodiments, the terms “obtain”, “obtained” and “obtaining”, as used with respect to a processor or data processing system mean (a) producing data by processing data, (b) retrieving data from storage, or (c) requesting and receiving data from a further data processing system.

In some embodiments, the terms “storage” and “data storage” as used herein mean one or more data storage devices, apparatus, programs, circuits, components, systems, subsystems, locations and storage media serving to retain data, whether on a temporary or permanent basis, and to provide such retained data.

In some embodiments, the terms “food serving identification data” and “food serving ID data” as used herein mean data of any kind that is sufficient to identify a food and to convey an amount thereof, whether by mass, weight, volume, or size, or by reference to a standard or otherwise defined food serving, or by amounts of constituents thereof. The terms “amount” and “amounts” as used herein refer both to absolute and relative measures.

In some embodiments, the terms “food identification data” and “food ID data” as used herein mean data of any kind that is sufficient to identify a food, whether or not such data conveys an amount thereof.

In some embodiments, the terms “indicator” or “graphical indicator” are used herein interchangeably and include a single or a plurality of visual presentations to convey information, including but not limited to, the plurality of presentations that show related or the same information or the plurality of presentations that show unrelated information.

It is understood that at least one aspect/functionality of the various embodiments described herein can be performed in real-time (or “in real time”) and/or dynamically. As used herein, the term “real-time”/“in real time” means that an event/action occurs instantaneously or almost instantaneously in time when another event/action has occurred. As used herein, the term “dynamic(ly)” means that an event/action occurs without any human intervention.

In some embodiments, a person's tracked living factors include, but are not limited to, food consumption, physical activity, mental activity, stress level, health, etc.

In some embodiments, the instant invention can provide for methods and systems for visually tracking a person's living factor(s) which serves to non-therapeutically reduce the weight of a person and/or for non-therapeutically maintaining the person's weight. In some embodiments, the instant invention can provide a software tool (e.g., a smart phone's application (“App”)) that determines/calculates, on the basis of collected data (e.g., tracking the person's living factor(s) and/or additional information such as person's current weight) that the person has maintained or lost weight.

In some embodiments, the instant invention visually tracks a person's living factor(s) to allow the person to maintain weight control (e.g., lose weight, maintain weight, etc.). In some embodiments, the instant invention visually tracks a person's living factor(s) over a period of time to maintain weight control. In some embodiments, the instant invention visually tracks a person's living factor(s) over a period of time to maintain weight control and/or allows the person to understand how the person's living factor(s) could be affected if the person is to engage in a certain activity (e.g., would decides to eat a particular food (he/she has a cupcake), run a mile, etc). In some embodiments, the instant invention visually tracks a combination of a plurality of living factors over a period of time.

In some embodiments, the instant invention visually tracks a running cumulative value(s) of a person's living factor(s) over a period of time (“actual RCV(t)”) to maintain weight control and/or reduce weight. In some embodiments, the instant invention visually tracks a running cumulative average value(s) of a person's living factor(s) over a period of time (“actual RCAV(t)”) to maintain weight control and/or reduce weight, and/or allow the person to understand how the person's living factor(s) could be affected if the person engages in a certain activity (e.g., eats a particular food (he/she has a cupcake), runs a mile, etc).

In some embodiments, the instant invention visually tracks the actual RCV(t) and/or the actual RCAV(t) of the person's living factor(s) by visually displaying a indicator (“the graphical indicator” or “visual indicator”) on a computer device, including but not limiting to, a hand-held computing mobile device or similar device. In some embodiments, the graphical indicator represents the actual RCV(t) and/or the actual RCAV(t) of the person's living factor(s) where “t” can be minutes, hours, days, months, years, and/or any other suitable time value. In some embodiments, the instant invention allows the person to understand how the person's living factor(s) could be affected if the person is to engage in a certain activity (e.g., would decide to eat a particular food (he/she has a cupcake), to run a mile, etc) by visually changing the graphical indicator (e.g., changing its position on the screen, changing its shape, changing its color, etc.) based on a potential RCV(t) and/or a potential RCAV(t) calculated when the person submits information about the certain activity that he or she considers to engage in (“what-if data”/“what-if scenarios”).

In some embodiments, personal computer device(s) programmed in accordance with the instant invention can further determine/calculate, on the basis of the collected data about the person's living factor(s), the person's progress in accomplishing personal goal(s) (e.g., going to the gym, eating a healthy snack, tracking your food intake and activity, getting a good night's sleep.)

As detailed further herein, in some embodiments of the instant invention, the actual RCV(t), the actual RCAV(t), the potential RCV(t), and/or the potential RCAV(t) can be calculated on the basis of various values/factors such as energy density (“ED”), food energy density (“FED”), total energy expenditure (“TEE”), adjusted TEE, healthfulness (“HD”), kcal, whole numbers (e.g., p, P_{A}) representative of the amount and/or extent to which the person engages in or considers to engage in a particular activity (e.g., perform medium intensity physical exercise), and other suitable values/factors.

In some embodiments, the visual tracking is representative of a targeted optimum/desired range within which the graphical indicator is shown. In some embodiments, the visual tracking is representative of a targeted optimum/desired value with respect to which the graphical indicator is shown. The targeted optimum/desired range and/or the targeted optimum/desired value allow(s) the person to visually compare outcome(s) of activities in which the person engages and/or considers to engage in. In some embodiments, the instant invention provides a functionality that displays a certain visual presentation and/or spatial mark(s) that is/are representative of the targeted optimum/desired range and/or the targeted optimum/desired value. In some embodiments, the targeted optimum/desired range and/or the targeted optimum/desired value are constant over a period of time. In some embodiments, the targeted optimum/desired range and/or the targeted optimum/desired value are adjusted, in real-time and/or periodically, over a period of time. In some embodiments, as detailed below, if the targeted optimum/desired value is a whole number to be achieved over 24 hours—e.g., pre-determined whole number benchmark (“PWNB”),—then, for example, the displayed visual representation of the targeted optimum/desired value at the eight hour will be adjusted to show that it is the third of the whole number.

Examples of Visually Tracking the Actual RCV(t), the Actual RCAV(t), the Potential RCV(t), and/or the Potential RCAV(t) Based on ED

For example, some embodiments of the instant invention are based on a relationship that the consumption of food having a lower ED translates into better control of weight maintenance and/or weight loss. In some embodiments, the actual RCAV(t) (ED) of the consumed and/or potential RCAV(t) (ED) contemplated to be consumed food is calculated over a time period (day, week, month, etc.) based, at least in part, on, but not limited to, the following equation:

RCAV(t)(ED)=(((amount of [kcal]of Food(1)/100 gram)×weight of consumed Food(1))+((amount of [kcal]of Food(2)/100 gram)×weight of consumed Food(2))+ . . . +((amount of [kcal]of Food(n)/100 gram)×weight of consumed Food(n)))/(weight of consumed Food(1)+weight of consumed Food(2)+ . . . +weight of consumed Food(n)) (1);

wherein “n” is the total number of Foods consumed by a person over the tracked time period (t). In some embodiments, the consumed Foods tracked by the instant invention exclude beverages other than milk or milk-based beverages.

In some embodiments, the RCAV(t) (ED) (time period) value may be calculated using various weight metric units (e.g., lb, kg, etc) and thus can be modified according to the weight metric unit. In some embodiments, the instant invention collects data about person's living factor(s) over a period of time (e.g., said data comprising data about food consumed by the person over the period of time.) In some embodiments, the instant invention can then calculate an actual RCAV(t) (ED) of the food consumed by the person over a period of time and display the graphical indicator to represent the person's calculated actual RCAV(t) (ED) of food consumed. In some embodiments, the instant invention can then calculate a potential RCAV(t) (ED) of the food contemplated to be consumed by the person at a particular point in time (e.g., the what-if scenarios).

In some embodiments, value(s) for energy and/or weight of foods consumed and/or to be consumed can be obtained from various sources which may include, but not limited to, food packaging, public/private database(s), etc. In some embodiments, personal electronic devices programmed in accordance with the instant invention have a functionality of automatically acquiring information about the energy and/or weight of foods consumed and/or to be consumed from food packaging and/or announcement (e.g., advertisement). In some embodiments, the functionality of automatically acquiring information can include, but is not limited to, a functionality of scanning (e.g., UPC, QR code), taking a picture (e.g., UPC, QR code), and/or wireless receiving data (e.g., near field communication (NFC), IR, etc.)

In some embodiments, the instant invention may exclude beverages from the calculation because beverages may significantly impact the actual/potential RCAV(t) (ED) value without contributing to a persons' feeling of being no longer hungry (i.e., food satisfied.)

In some embodiments, the tracking period (t) can be a fixed period of time (e.g., daily, weekly, monthly.) In some embodiments, the tracking period (t) can be adapted to be pre-determined by the person (e.g., daily, weekly, monthly.) In some embodiments, the tracking period (t) can be adapted to be changed by the person in real-time. In one example, a reset button can be provided whose activation will return the graphical indicator to baseline and the process will begin anew.

In some embodiments, the actual/potential RCAV(t) (ED) value can be further adjusted to account for volume of air and/or water in a particular consumed food. For example, popcorn contains a high volume of air. Popcorn's energy value per 100 gram (3.5 oz) is about 1,598 kJ (382 kcal) which would correspond to ED of 3.82 (kcal/gram). The consumption of one cup of popcorn (about 8 grams) would correspond to an ED of 0.31 of a consumed amount which is further adjusted down by taking into consideration the volume of air. In some embodiments, a weight of the volume of air is calculated as being the same as the weight of water occupying the same volume. For example, in some embodiments, the instant invention assumes for calculation(s) the person's the actual/potential RCAV(t) (ED) value that weight of a cup (8 oz.) of popcorn is equal to weight of a cup (8 oz.) of water.

In some embodiments, the instant invention can provide a functionality of separately tracking consumption of beverages without using beverage data in the person's the actual/potential RCAV(t) (ED) value calculation above. In one instance, the device programmed in accordance with the principles of the instant invention, prevents the submission of data about the consumed or to be consumed beverages such as orange juice that the person drank or intends to drink during a particular time period (t)(e.g., day, week). Consequently, in such embodiments, the instant invention will not use the orange juice data in the calculation of the person's actual/potential RCAV(t) (ED) value.

In some embodiments, the instant invention accounts for milk (animal and plant origin) separately from other beverages.

In some embodiments, the instant invention provides a software tool (e.g., an App) on a computer device, including but not limited to, a hand-held computing mobile device (e.g., smart phone-type device, iPad-type device, etc.) that assists the person in visually tracking the actual/potential RCAV(t) (ED) value for controlling living factor(s) including consumption of food for weight maintenance and/or weight loss. In some embodiments, the visual tracking of the actual/potential RCAV(t) (ED) value guides the person toward consumption of foods having a lower ED.

In some embodiments, the instant invention can provide a functionality of automatically resetting the actual/potential RCAV(t) (ED) value on a pre-determined periodic basis. In some embodiments, the instant invention can provide a functionality of allowing the person/person to manually reset the actual/potential RCAV(t) (ED) value.

In some embodiments, the software tool can include a graphical display with at least one indicator that has a particular shape (e.g., bubble shape, a level, etc.) and/or is spatially positioned within the graphical display such as to convey to the person' actual/potential RCAV(t) (ED) value with respect to a targeted optimum/desired range and/or value.

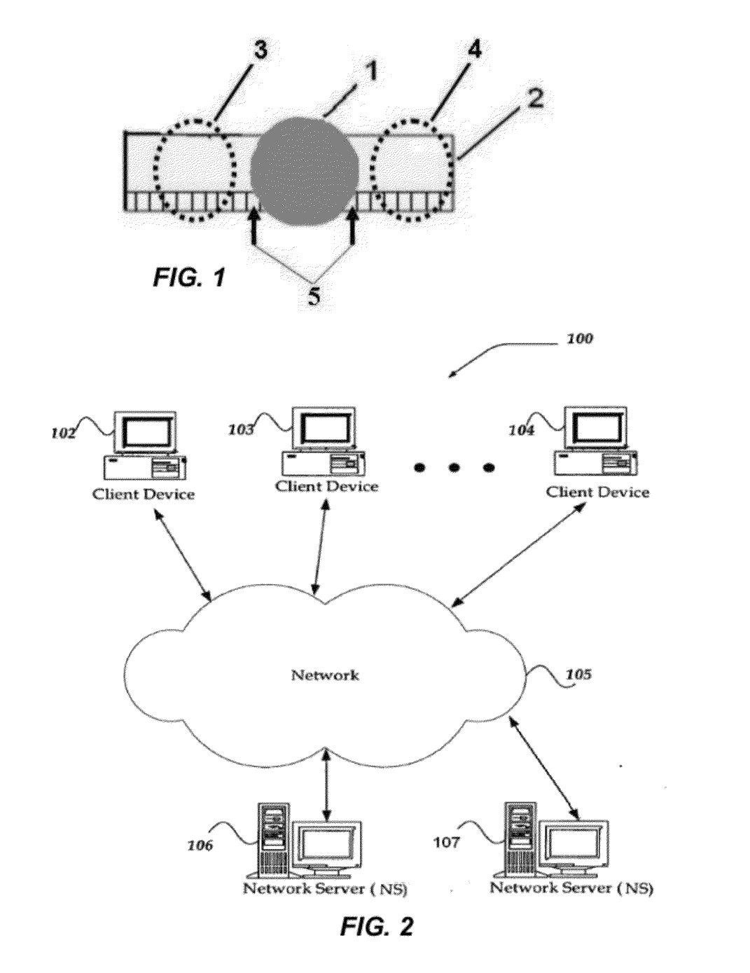

Examples of FIG. 1

In some embodiments, as shown in FIG. 1, as the software receives data about food(s) consumed by the person, the at least one graphical indicator, which can be in a form of a bubble (1), can be adapted to move, for example, from-left-to-right (3,4) on a scale (2) to reflect the person's most recent actual/potential RCAV(t) (ED) value. In some embodiments, the scale (2) represents a food ED scale, having a range between 0 kcal/gram, corresponding to an ED of water, and 9 kcal/gram, corresponding to an ED of oil. In some embodiments, the consumption of different foods would result in change in a position of the at least one graphical indicator along the food ED scale that conveys the person's actual/potential RCAV(t) (ED) at a particular time. For example, an ED of a banana is 0.6 (kcal/gram), assuming that the banana weighs 100 grams and contains 60 kcal. For example, an ED of a celery portion is 0.5 (kcal/gram). For example, an ED of watermelon is 0.25 (kcal/gram) because a watermelon is mostly water. For example, an ED of oil is 9 (kcal/gram), the highest possible ED value among foods.

In one example, if the person tracks his/her actual/potential RCAV(t) (ED) on a daily basis, at a particular time during a day, for example, at 3 PM, the position of the graphical indicator (1) along the scale (2) will represent the person's real-time actual/potential RCAV(t) (ED) value based on the foods that the person consumed prior to 3 PM for control of weight maintenance and/or weight loss. In one example, if the graphical indicator (1) is positioned closer to the right end (4) of the scale (2), the person receives a real-time visual indication that, from this time and on, he or she needs to eat foods that have a low ED to maintain weight control and/or lose weight until the next calculation when the person consumes the next food. In one example, if the graphical indicator (1) is positioned closer to the left end (3) of the scale (2), the person receives a real-time visual indication that, from this time and on, he or she can eat foods that do not necessarily have a lower ED for control of weight maintenance and/or weight loss until the next calculation when the person consumes the next food. In one example, the visual tracking is representative of a pre-determined targeted optimum/desired range. This targeted range then allows the person to visually track a target range for control of weight maintenance and/or weight loss so as to determine whether the person is “under” or “over” the target range.

In one example, the person tracks his/her actual/potential RCAV(t) (ED) on a daily basis. For example, the person enters a breakfast of mixed fruit and low-calorie oatmeal and, as a result, the position of the graphical indicator along the scale (2) will be at position (1) because the foods eaten have a combined ED that is less than the target. As such, the visual tracking is representative of a pre-determined target (optimum/desired). This target then may result in control of weight maintenance and/or weight loss. Consequently, in one example, this shows a certain visual presentation and/or spatial mark(s) within the display that is representative of a pre-determined targeted (optimum/desired) ED value or range to which a visual condition of the at least one indicator of the person's actual/potential RCAV(t) (ED) value is compared to. Therefore, the graphical indicator provides a real-time visual indication that, for the next foods selected (i.e., lunch), choices with a higher ED can be consumed (e.g., a sandwich) to reach the target value.

In yet another example, the person tracks his/her actual/potential RCAV(t) (ED) on a daily basis. For example, the person enters a breakfast of French toast with butter and syrup, the position of the graphical indicator along the scale (2) will be at position (4) because the foods eaten have a combined ED that is greater than the target. As such, the visual tracking is representative of a pre-determined optimum/desired target. This target then may result in control of weight maintenance and/or weight loss. The graphical indicator provides a real-time visual indication that, for the next foods selected (i.e., lunch), choices with a lower ED can be consumed (e.g., soup and salad) to reach the target value.

In yet another example, a person tracks his/her actual/potential RCAV(t) (ED) on a weekly basis (Friday-to-Friday.) A person enters all foods eaten over a weekend of socializing, the position of the graphical indicator along the scale (2) will be at position (4) because the foods eaten have a combined ED that is greater than the target. The graphical indicator provides a real-time visual indication that, for the next several meals and/or days food choices with a lower ED need to be consumed to reach the target value.

In another example, the person tracks his/her actual/potential RCAV(t) (ED) on a weekly basis (Monday-to-Monday). By consistently choosing foods with a lower ED for several days, the position of the graphical indicator along scale (2) will be at position (3) because the foods eaten have a combined ED that is less than the target. The graphical indicator provides a real-time visual indication that, for the next few meals and/or days, foods choices with a higher ED need to be consumed to reach the target value by week's end.

In some embodiments, the graphical display can be programmed to show a certain visual presentation and/or spatial mark(s) within the display that is representative of a pre-determined optimum/desired targeted ED value or range to which a visual condition of the at least one indicator of the person's RCAV(t) (ED) value is compared to. This then allows the person to visually track an RCAV (ED) (time period) value for control of weight maintenance and/or weight loss. In some embodiments, the pre-determined targeted optimum/desired ED range of the actual/potential RCAV(t) (ED) value is 0.5-1.6 kcal/gram. In some embodiments, the pre-determined targeted optimum/desired ED range of the actual/potential RCAV(t) (ED) value is 0.8-1.2 kcal/gram. In some embodiments, the pre-determined targeted optimum/desired ED range of the actual/potential RCAV(t) (ED) value is 1-1.25 kcal/gram. In some embodiments, the targeted pre-determined optimum/desired ED range of the actual/potential RCAV(t) (ED) value is 0.8-0.9 kcal/gram.

In one example, the person's pre-determined targeted optimum/desired ED range on the scale (2) is defined by arrows (5). In one example, if the person tracks the actual/potential RCAV(t) (ED) on a daily basis and, at a particular time during a day, for example, at 3 PM, the graphical indicator (1) is within the range defined by arrows (5), i.e. within his or her pre-determined targeted optimum/desired ED range. Then, the person receives a real-time visual indication that, from this time and on, he or she needs to eat foods that have ED within the person's pre-determined targeted optimum/desired ED range for control of weight maintenance and/or weight loss until the next calculation when the person consumes the next food.

In one example, the person tracks the actual/potential RCAV(t) (ED) value on a daily basis and, at a particular time during a day, for example, at 3 PM, the graphical indicator (1) is to the right (4) of the range defined by arrows 105, i.e. to the right of his/her pre-determined targeted optimum/desired ED range. Then, the person receives a real-time visual indication that, from this time and on, he/she needs to eat foods that have a lower ED than the person's pre-determined targeted ED range to control his/her weight maintenance and/or weight loss until the next calculation is performed when the person consumes the next food.

In one example, the person tracks the actual/potential RCAV(t) (ED) value on a daily basis and, at a particular time during a day, for example, at 3 PM, the graphical indicator (1) is to the left (3) of the range defined by arrows (5), i.e. to the left of his/her pre-determined targeted ED range. Then, the person receives a real-time visual indication that, from this time and on, he/she can eat foods that have a higher ED than the person's pre-determined targeted ED range and would still maintain weight control and/or lose weight until the next calculation when the person consumes the next food.

In some embodiments, the at least one indicator can be programmed to allow the person to measure the actual/potential RCAV(t) (ED) value over an extended period of time (weeks, months, etc.) In some embodiments, the instant invention receives data about foods consumed by the person and, based on the data, adjusts the at least one indicator's visual presentation and/or spatial positioning within the display to reflect (1) ED or (2) ED and energy value of the consumed food.

In some embodiments, the instant invention can provide a functionality of inquiring to at least one food database to determine the ED of the consumed food based on the consumed food's ingredient(s)/nutrient(s) and the consumed amount. In some embodiments, the at least one food database is remotely located with respect to the person's computer device. In some embodiments, the at least one food database resides at a person's computer device and is updated periodically and/or automatically (e.g., real-time).

In some embodiments, the instant invention can provide a functionality of allowing a person's computer device of the instant invention to communicate with a website (e.g., weight management website) to integrate information gathered or provided by a person's computer device of the instant invention into a weight control/management product offered by the website.

For example, in some embodiments, the instant invention can additionally visually track a person's physical activity over a period of time. For example, in some embodiments, the instant invention visually tracks, over a period of time, both a person's physical activity and the actual/potential RCAV(t) (ED) value as parts of the same equation.

Examples of Illustrative Operating Environments

Examples of FIG. 2

FIG. 2 illustrates one embodiment of an environment in which the present invention may operate. However, not all of these components may be required to practice the invention, and variations in the arrangement and type of the components may be made without departing from the spirit or scope of the invention. In some embodiments, the instant invention can host a large number of persons and concurrent transactions. In other embodiments, the instant invention can be based on a scalable computer and network architecture that incorporates varies strategies for assessing the data, caching, searching, and database connection pooling. An example of the scalable architecture is an architecture that is capable of operating multiple servers.

In embodiments, persons' computer devices 102-104 include virtually any computing device capable of receiving and sending a message over a network, such as network 105, to and from another computing device, such as servers 106 and 107, each other, and the like. In embodiments, the set of such devices includes devices that typically connect using a wired communications medium such as personal computers, multiprocessor systems, microprocessor-based or programmable consumer electronics, network PCs, and the like. In embodiments, the set of such devices also includes devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, in embodiments, persons' computer devices 102-104 are any device that is capable of connecting using a wired or wireless communication medium such as a PDA, POCKET PC, wearable computer, and any other device that is equipped to communicate over a wired and/or wireless communication medium.

In some embodiments, each person computer device within client devices 102-104 can include a browser application that is configured to receive and to send web pages, and the like. In embodiments, the browser application is configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, JavaScript, and the like. In embodiments, persons' computer devices 102-104 can be programmed in either Java or .Net.

In some embodiments, persons' computer devices 102-104 are further configured to receive a message from the another computing device employing another mechanism, including, but not limited to email, Short Message Service (SMS), Multimedia Message Service (MMS), instant messaging (IM), internet relay chat (IRC), mIRC, Jabber, and the like.

In some embodiments, network 105 is configured to couple one computing device to another computing device to enable them to communicate. In embodiments, network 105 is enabled to employ any form of computer readable media for communicating information from one electronic device to another. Also, in embodiments, network 105 includes a wireless interface, and/or a wired interface, such as the Internet, in addition to local area networks (LANs), wide area networks (WANs), direct connections, such as through a universal serial bus (USB) port, other forms of computer-readable media, or any combination thereof. In embodiments, on an interconnected set of LANs, including those based on differing architectures and protocols, a router acts as a link between LANs, enabling messages to be sent from one to another.

Also, in some embodiments, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, in embodiments, remote computers and other related electronic devices could be remotely connected to either LANs or WANs via a modem and temporary telephone link. In essence, in embodiments, network 105 includes any communication method by which information may travel between client devices 102-104, and servers 106 and 107.

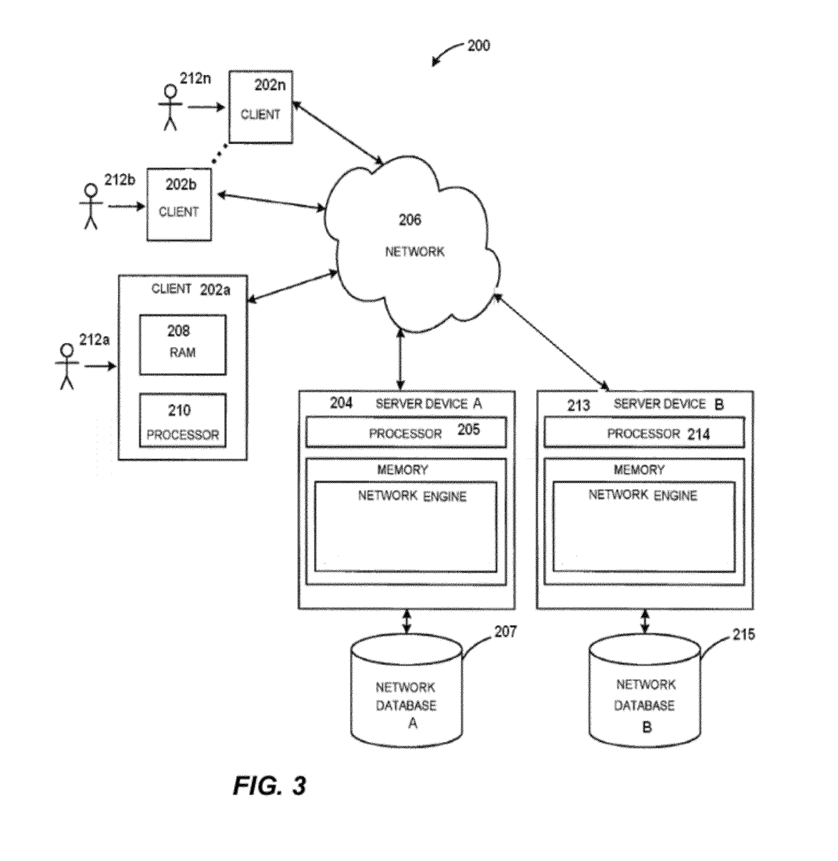

Examples of FIG. 3

FIG. 3 shows the computer and network architecture of some embodiments of the instant invention. The persons' computer devices 202a, 202b thru 202n shown, each comprises a computer-readable medium, such as a random access memory (RAM) 208 coupled to a processor 210. The processor 210 executes computer-executable program instructions stored in memory 208. Such processors comprise a microprocessor, an ASIC, and state machines. Such processors comprise, or are be in communication with, media, for example computer-readable media, which stores instructions that, when executed by the processor, cause the processor to perform the steps described herein. Embodiments of computer-readable media include, but are not limited to, an electronic, optical, magnetic, or other storage or transmission device capable of providing a processor, such as the processor 210 of client 202a, with computer-readable instructions. Other examples of suitable media include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media transmit or carry instructions to a computer, including a router, private or public network, or other transmission device or channel, both wired and wireless. The instructions comprise code from any computer-programming language, including, for example, C, C++, C#, Visual Basic, Java, Python, Perl, and JavaScript.

The persons' computer devices 202a-n can also comprise a number of external or internal devices such as a mouse, a CD-ROM, DVD, a keyboard, a display, or other input or output devices. Examples of persons' computer devices 202a-n are personal computers, digital assistants, personal digital assistants, cellular phones, mobile phones, smart phones, pagers, digital tablets, laptop computers, Internet appliances, and other processor-based devices. In general, a person device 202a are be any type of processor-based platform that is connected to a network 206 and that interacts with one or more application programs. The persons' computer devices 202a-n operate on any operating system capable of supporting a browser or browser-enabled application, such as Microsoft™, Windows™, or Linux. The persons' computer devices 202a-n shown include, for example, personal computers executing a browser application program such as Microsoft Corporation's Internet Explorer™, Apple Computer, Inc.'s Safari™, Mozilla Firefox, and Opera.

Through the persons' computer devices 202a-n, persons 212a-n of the instant invention can communicate over the network 206 with a centralized computer system, and/or each other, and/or with other systems and devices coupled to the network 206. As shown in FIG. 3, server devices 204 and 213 are also coupled to the network 206.

In some embodiments, the instant invention can utilize NFC technology to obtain/transmit information. In some embodiments, NFC can represent a short-range wireless communications technology in which NFC-enabled devices are “swiped,” “bumped,” “tap” or otherwise moved in close proximity to communicate. In some embodiments, NFC could include a set of short-range wireless technologies, typically requiring a distance of 10 cm or less. In some embodiment, NFC can operates at 13.56 MHz on ISO/IEC 18000-3 air interface and at rates ranging from 106 kbit/s to 424 kbit/s. In some embodiments, NFC can involve an initiator and a target; the initiator actively generates an RF field that can power a passive target. In some embodiment, this can enable NFC targets to take very simple form factors such as tags, stickers, key fobs, or cards that do not require batteries. In some embodiments, NFC peer-to-peer communication can be conducted when a plurality of NFC-enable device within close proximity of each other.

In some embodiments, NFC tags can contain data and be read-only or rewriteable. In some embodiment, NFC tags can be custom-encoded. In some embodiments, NFC tags and/or NFC-enabled device (e.g., smart phones with NFC capabilities) can securely store personal data such as debit and credit card information, loyalty program data, PINs and networking contacts, and/or other information. NFC tags can be encoded to pass a Uniform Resource Locator (URL) and a processor of the NFC-enabled device can automatically direct a browser application thereof to the URL without prompting for permission to proceed to the designated location.

In some embodiments, lottery data may also be communicated using any wireless means of communication, such as 4G, 3G, GSM, GPRS, WiFi, WiMax, and other remote local or remote wireless communication using information obtained via the interfacing of a wireless NFC enabled mobile device to another NFC enabled device or a NFC tag. In some embodiments, the term “wireless communications” includes communications conducted at ISO 14443 and ISO 18092 interfaces. In some embodiments, the communications between person's NFC-enabled smart device and lottery provided equipment (e.g., terminals, POS, POE, Hosts) is performed, for example, in accordance with the ISO 14443A/B standard and/or the ISO 18092 standard.

In some embodiments, player's NFC-enabled smart device and/or lottery provided equipment (e.g., terminals, POS, POE, Hosts) can include one or more additional transceivers (e.g., radio, Bluetooth, and/or WiFi transceivers) and associated antennas, and enabled to communicate with each other by way of one or more mobile and/or wireless protocols. In some embodiments, NFC tags can include one or more integrated circuits.

In some embodiments, person's NFC-enabled smart device may include a cellular transceiver coupled to the processor and receiving a cellular network timing signal. In some embodiments, person's NFC-enabled smart device may further include a satellite positioning receiver coupled to the processor and receiving a satellite positioning system timing signal, and the processor may accordingly be configured to synchronize the internal timing signal to the satellite positioning system timing signal as the external timing signal. In some embodiments, the processor of person's NFC-enabled smart device may be configured to synchronize the internal timing signal to the common external system timing signal via the NFC circuit.

Another Examples of Visually Tracking the Actual RCV(t), the Actual RCAV(t), the Potential RCV(t), and/or the Potential RCAV(t) Based on ED

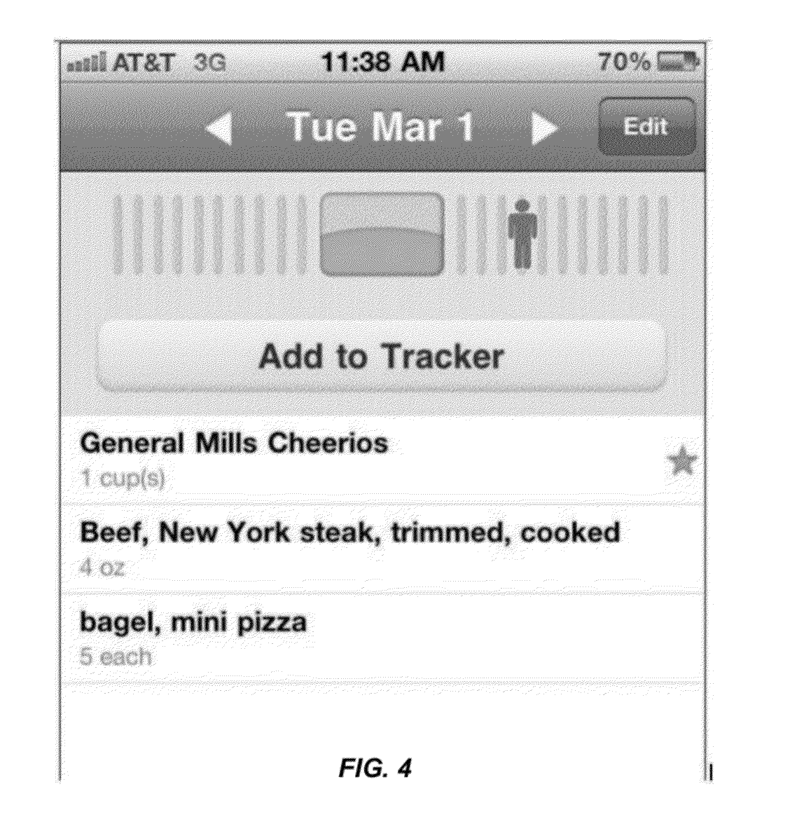

Examples of FIG. 4

FIG. 4 illustrates, for example, the scale, the graphical indicator in a shape of a person, and the position of the graphical indicator with respect to a particular optimum/desired range identified on the scale, in accordance with some embodiments of the present invention. FIG. 4 shows that on Tuesday, Mar. 1^{st}, a computer device programmed in accordance with the instant invention could receive information about a hypothetical person that can identify 3 foods and an amount of each of three foods that the person has consumed or contemplates to consume. Then, the programmed device of the instant invention and/or a remotely located computer system of the instant invention, in accordance with some embodiments, calculates the actual RCAV(t) (ED) value of the person if food has been consumed or the potential RCAV(t) (ED) value (what-if scenario) if the person would have consumed these three foods. Subsequently, the instant invention would adjust the visual positioning of the graphical indicator on the scale to show the actual/potential RCAV(t) (ED) value of the person with respect to the pre-determined optimum/desired range/value of the ED. In some embodiments, the pre-determined optimum/desired range/value can be a single number value or a position on the scale. FIG. 4, for example, conveys to the person that he or she needs to eat low ED foods to bring the graphical indicator (i.e., the person's the actual/potential RCAV(t) (ED) value) within the optimum/desired range. In some embodiments, the computer devices programmed in accordance with the instant invention can track the progress of person's weight maintenance and/or weight loss.

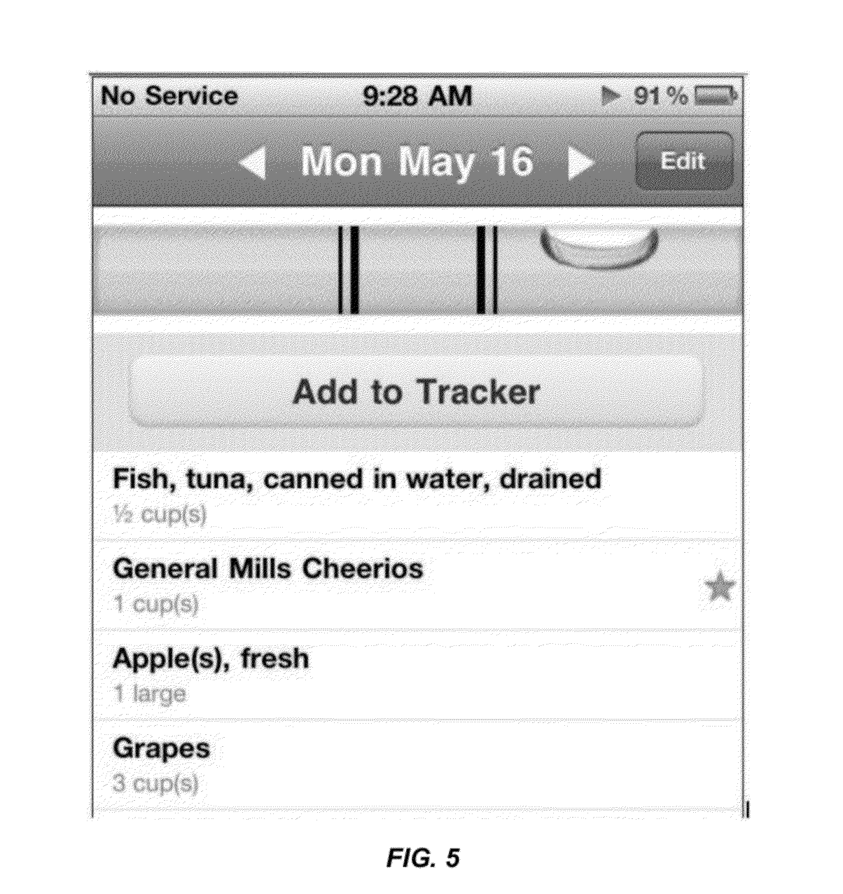

Examples of FIG. 5

FIG. 5 illustrates, for example, the scale, the graphical indicator and a position of the graphical indicator with respect to a pre-determined target optimum/desired range/value identified on the scale, in accordance with some embodiments of the present invention. As shown in FIG. 5, the visual tracking provides to the person the real-time information that, for example, the person's actual/potential RCAV(t) (ED) value exceeds the pre-determined targeted optimum/desired range of ED based on the current food intake and/or potential future food intake.

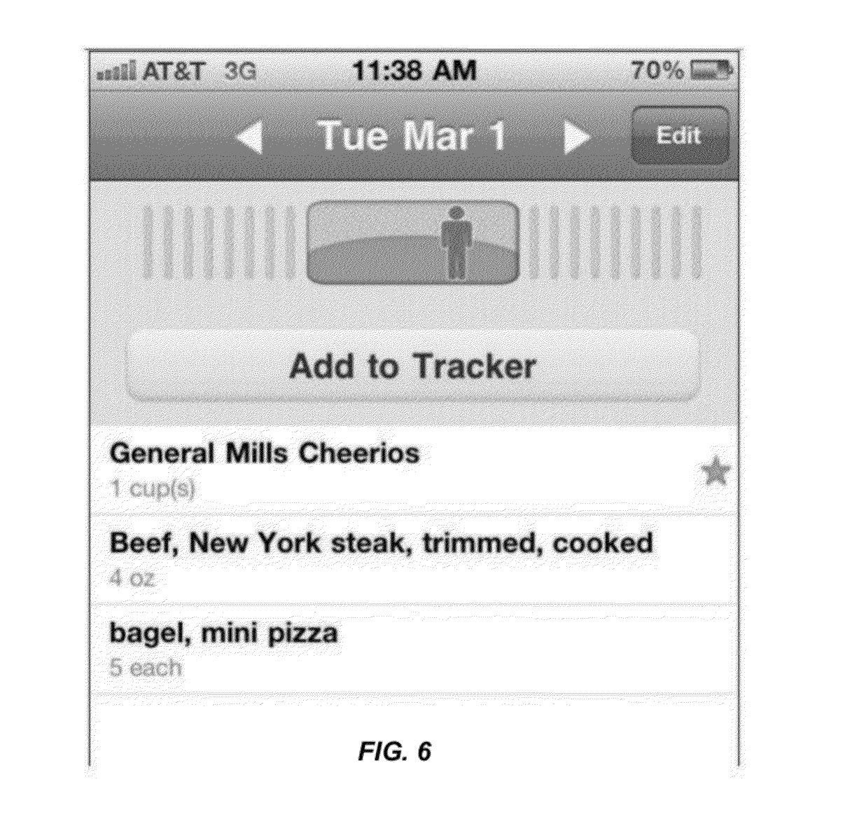

Examples of FIG. 6

FIG. 6 illustrates, for example, the scale, the graphical indicator and a position of the graphical indicator with respect to a pre-determined targeted optimum/desired range/value identified on the scale, in accordance with some embodiments of the present invention. As shown in FIG. 6, the visual tracking provides to the person the real-time information that, for example, the person's actual/potential RCAV(t) (ED) value is within the pre-determined targeted optimum/desired range/value of ED based on the current food intake and/or potential future food intake.

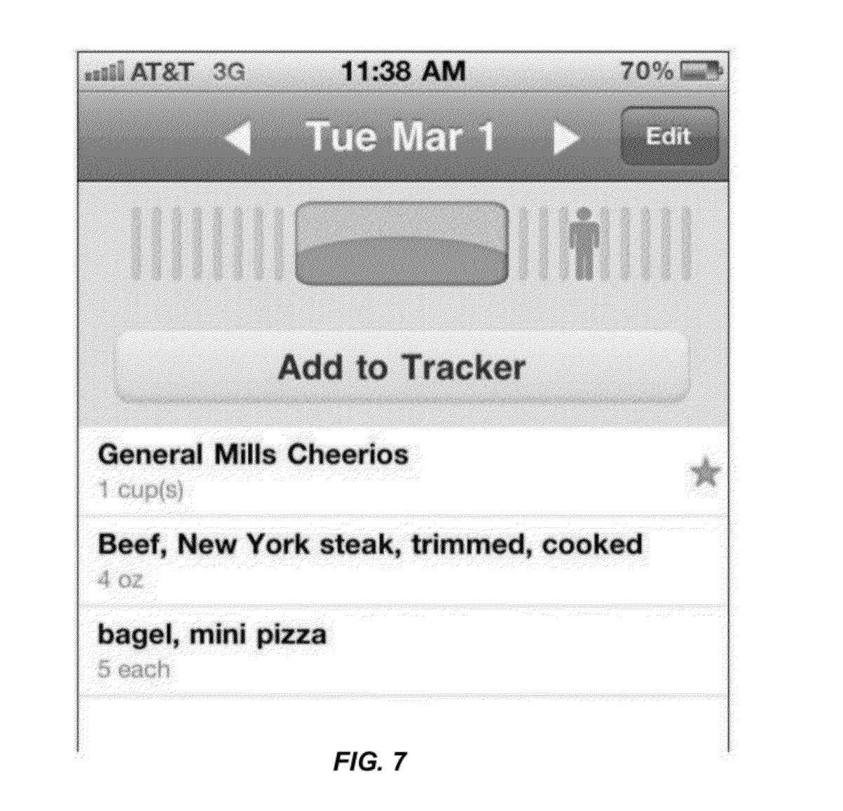

Examples of FIG. 7

FIG. 7 illustrates, for example, the scale, the graphical indicator and a position of the indicator with respect to a pre-determined targeted optimum/desired range/value identified on the scale, in accordance with some embodiments of the present invention. FIGS. 4 and 7 show that the size of the pre-determined targeted optimum/desired range/value can vary. In some embodiments, the size of the pre-determined targeted optimum/desired range/value can vary based, at least in part, on person's individual characteristic(s). In some embodiments, the size of the pre-determined targeted optimum/desired range can vary based on characteristic(s) of a group of persons within which the person is categorized by the instant invention.

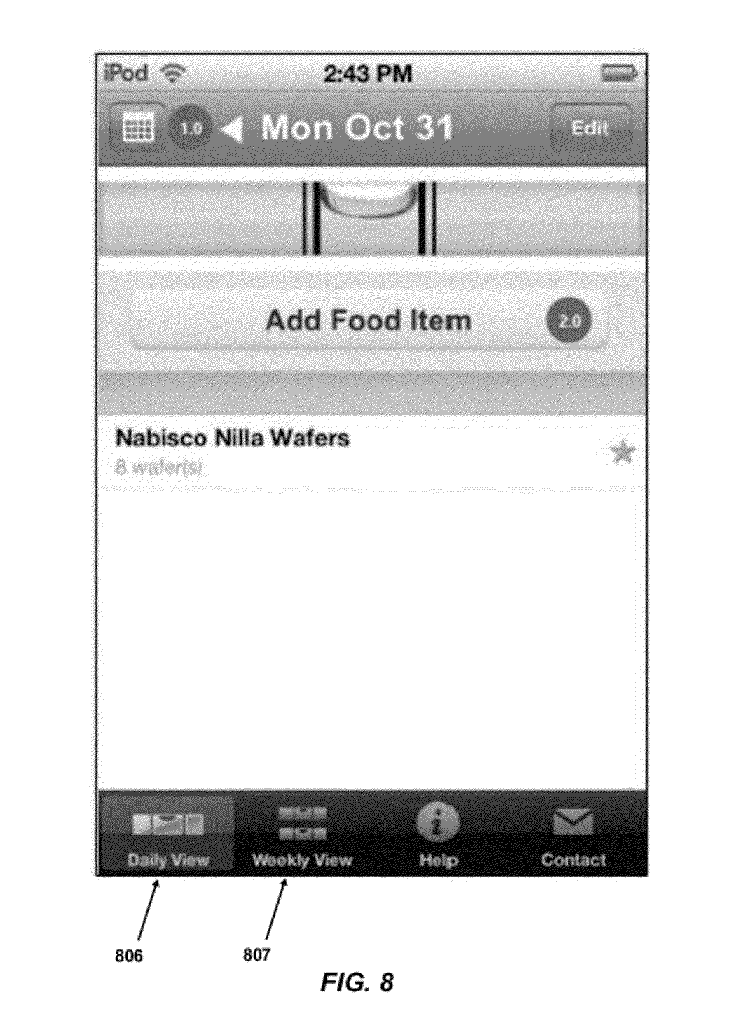

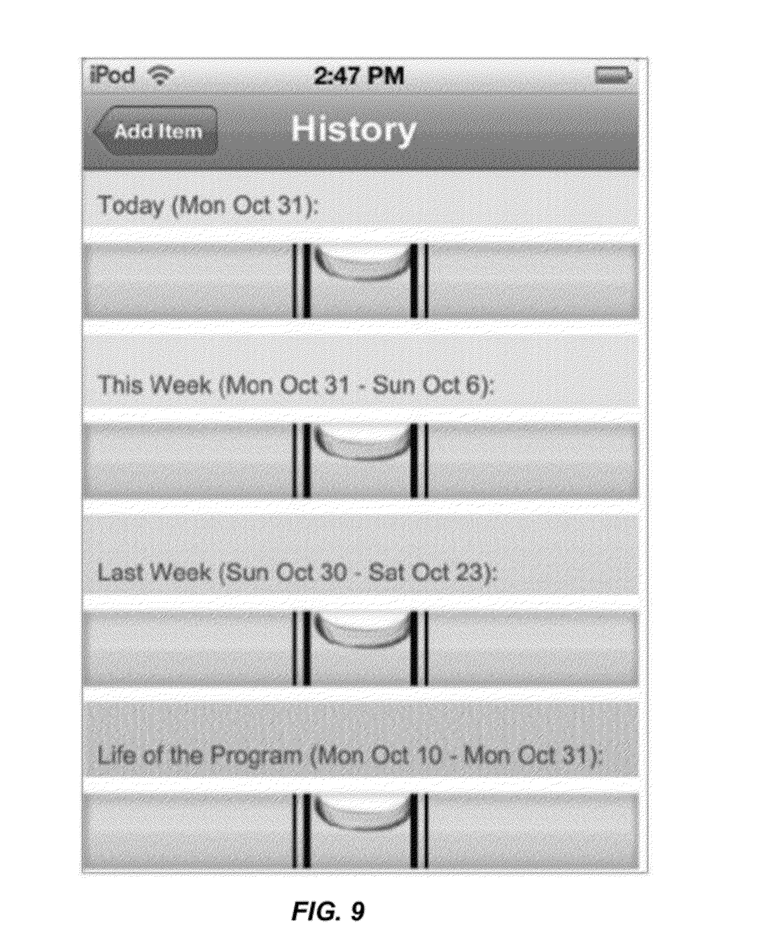

Examples of FIGS. 8 and 9

As shown in FIG. 8, the instant invention can provide a visual historical prospective to the tracked living factor(s) of the person. For example, by selecting an option (806), the instant invention provides a visual history prospective on the person's living factor(s) during a particular day (“Daily View.”) For example, by selecting an option (807), the instant invention provides the visual history prospective on the person's living factor(s) during a particular week (“Weekly View.”) In some embodiments, the person is not required to re-set the visual tracking because of the offered functionality to receive the visual history of the tracking his or her individual living factor(s). In some embodiments, the person is presented, at the same time, with one or more visual snapshots of historical information for particular period(s) of time. For example, as shown in FIG. 9, the person is presented with visual historical information for his or her status for four time periods: 1) the status as of the current date; 2) the status for the current week as of the current date; 3) the status for the previous week; and 4) the status since the beginning of the visual tracking and/or since the last re-set.

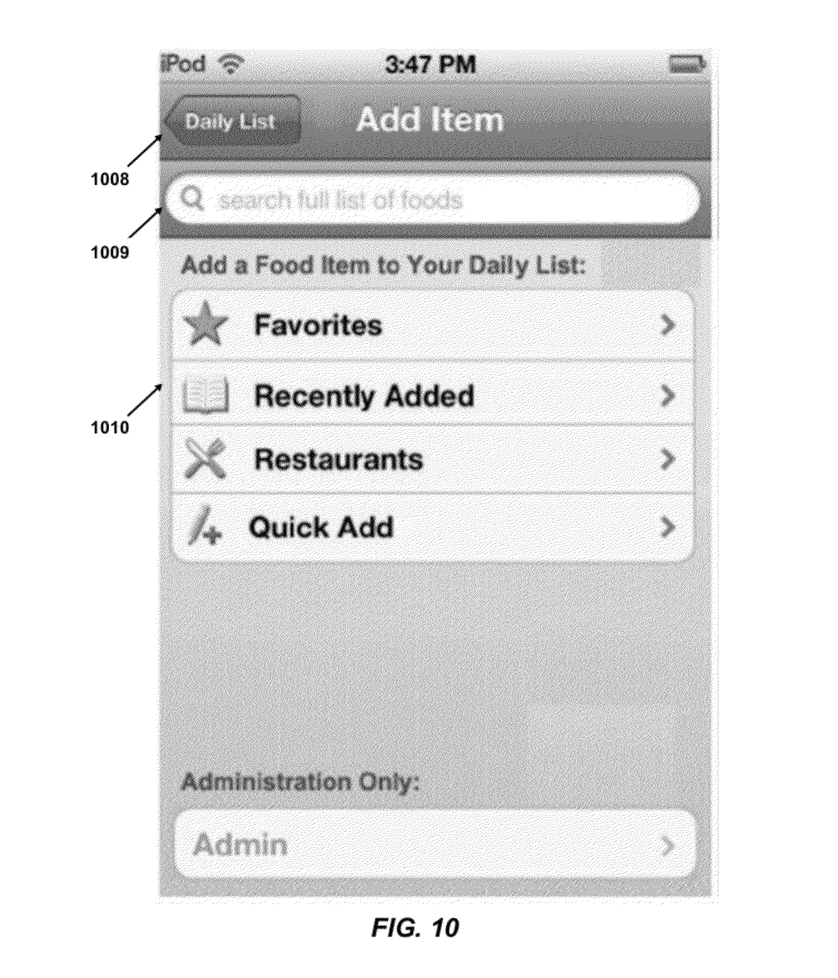

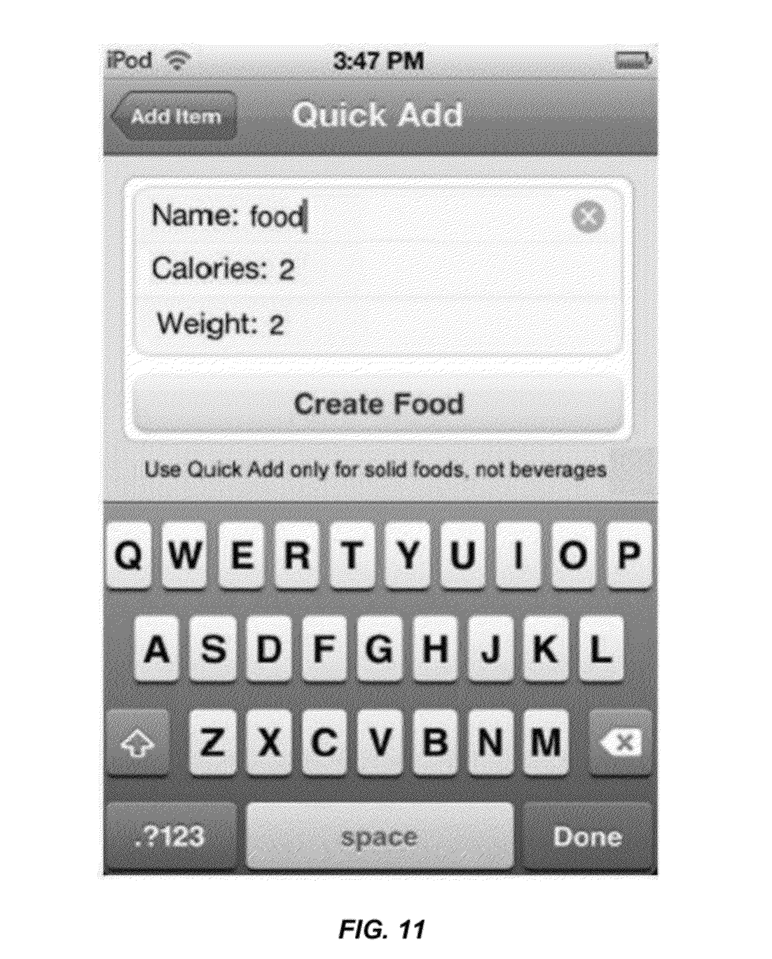

Examples of FIGS. 10 and 11

In some embodiments, the person is presented with a functionality to store within the App and/or the programmed computer system of the instant invention one or more foods that the person repeatedly consumes and/or intends to consume. For example, as shown in FIG. 10, the App and/or the programmed computer system of some embodiments of the instant invention can store one or more lists of foods that the person consumes and/or intends to consume on the daily basis (1008). For instance, the person can have a first list for Monday and Tuesday, have another list for Wednesday, and/or have another list for Wednesday through Sunday. In another example, as shown in FIG. 10, the App and/or the programmed computer system of some embodiments of the instant invention can offer a functionality to search (1009) one or more databases (e.g., private and/or public databases) for a certain food if the person does not know the ingredient(s) of a particular food and/or the ingredient(s)' amount(s), energy value(s), etc. For example, the person can submit a brand name or a type of food, and the search functionality would guide the person through the search wizard to identify the exact food of interest. In another example, the person can submit a restaurant name, and the search functionality (1009) would guide the person through a menu of that particular restaurant to identify food(s) consumed and/or contemplated to be consumed and determine the ED values and other characteristics of the food. In yet another example, after the search functionality (1009) has identified a particular food, the App and/or the programmed computer system of some embodiments of the instant invention can store the identified food in a database and associated the food with the person so that the food can be recalled in the future without the searching.

For example, as shown in FIG. 11, the App and/or the programmed computer system of some embodiments of the instant invention can offer a functionality to the person to submit information about the food that the person consumes and/or considers to consume (e.g., “what-if” scenarios) if the person already knows such information. For example, as shown in FIG. 11, the person may know a name of the food, a portion size, calories, or other characteristics (see examples below.) Further, as shown in FIG. 11, the App and/or the programmed computer system of some embodiments of the instant invention can restrict the person from submitting information about the consumption of beverages such as non-milk-based beverages.

Further, the App and/or the programmed computer system of some embodiments of the instant invention provide a functionality to determine a future effect of engaging and/or abstaining from particular activity(ies) (e.g., eating a banana, not eating a banana, eating two bananas, running a mile, running two miles, not running two miles, etc.)—a forward looking what-if scenarios. For example, after the person submits information about a particular what-if scenario, the App and/or the programmed computer system of some embodiments of the instant invention provides a visual output to show how the characteristic(s) of the graphical indicator change(s) (e.g., its shape, color, position, etc.) would change with respect to the optimum range of the ED shown in FIGS. 4-7. For instance, with respect to FIG. 4, the instant invention can determine and visually inform the person by moving the graphical indicator more towards the right end of the scale (i.e., further away from the target optimum/desired range) or moving the graphical indicator more towards the target optimum/desired range what would happen if the person eats a particular food (e.g., a cupcake).

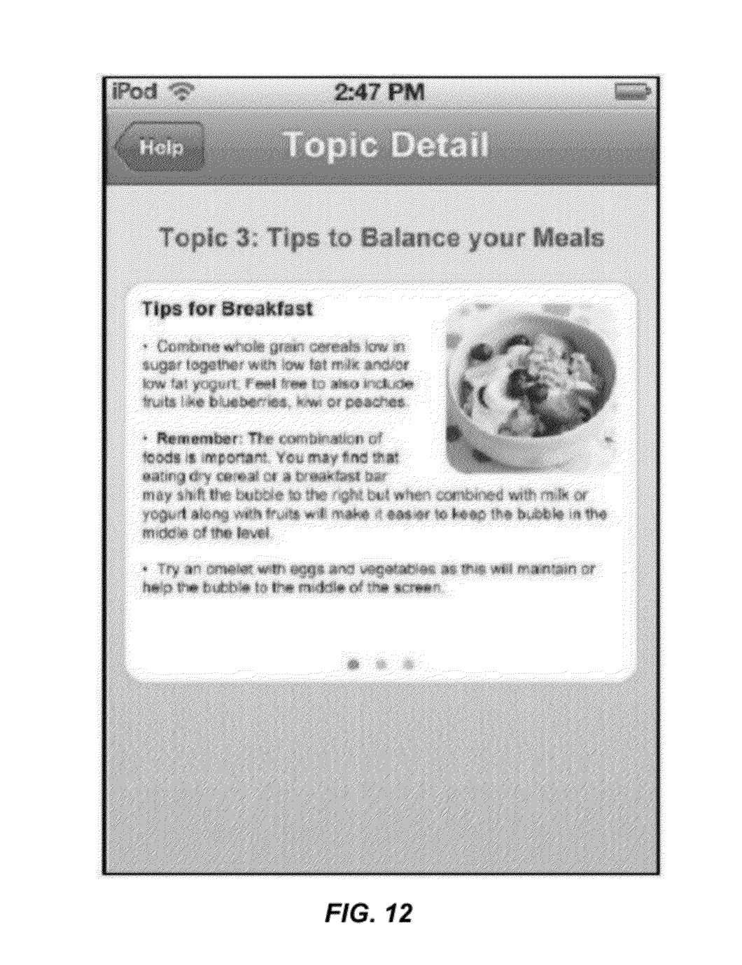

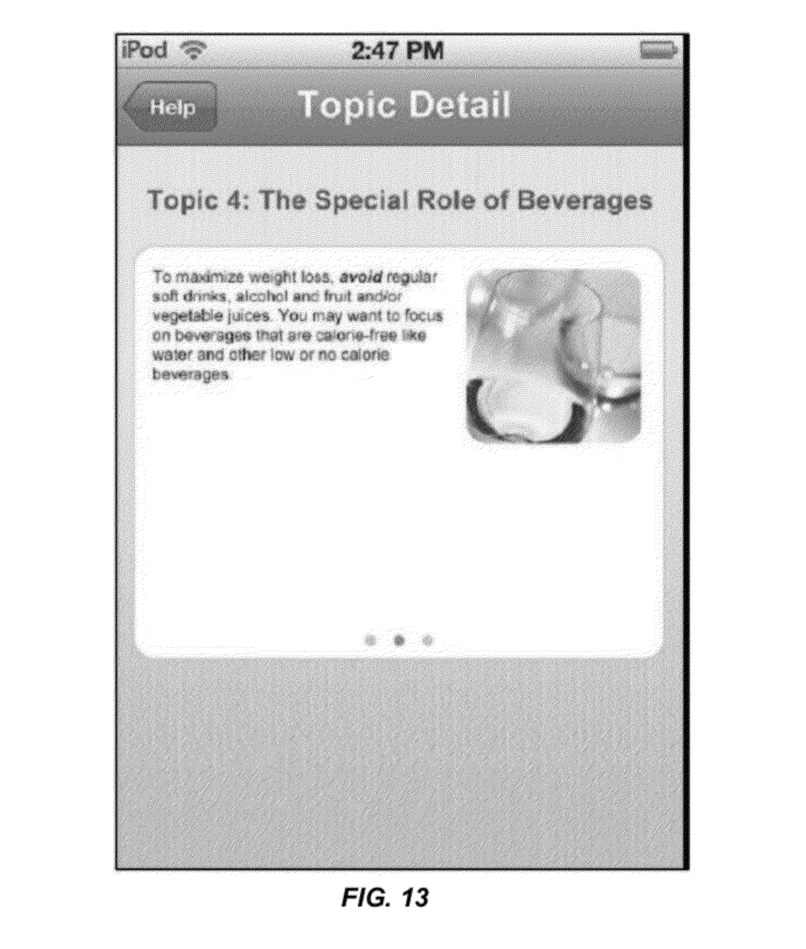

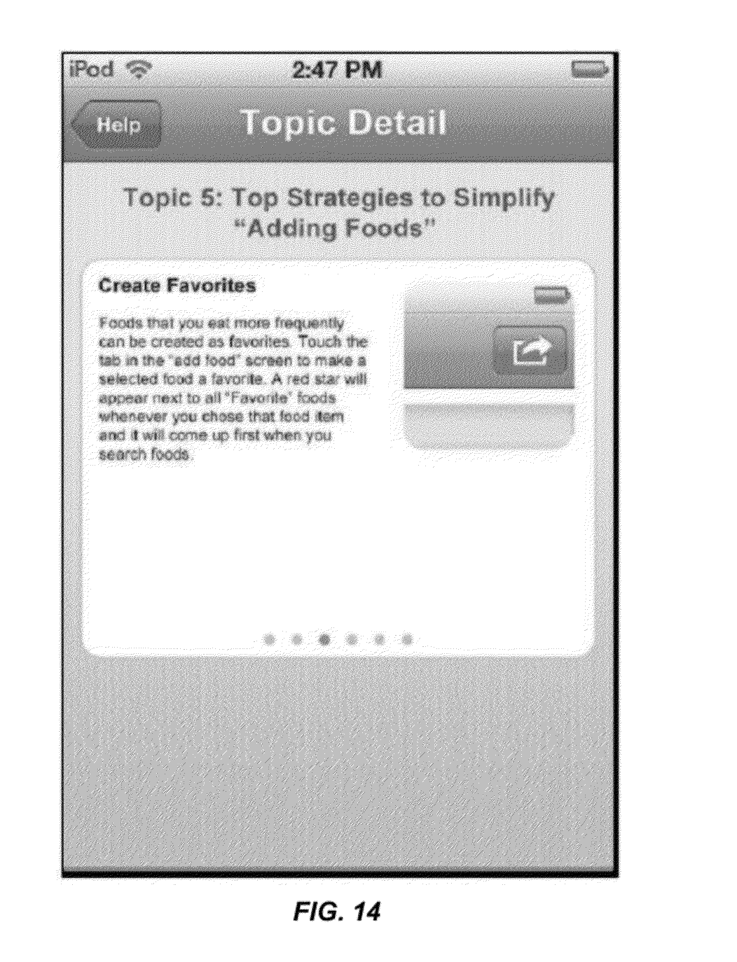

Examples of FIGS. 12-14

In some embodiments, as shown in FIGS. 12-14, the instant invention provides functionality(ies) that allow(s) the person to actively switch between the presentation of the graphical indicator of the visual tracking and practical advices that are provided based on particular activity(ies) that the person has engaged or considers to engage in (e.g., what-if scenarios). For example, if the person consumed certain food, the App and/or the programmed computer system of the instant invention adjust the visual representation of the graphical indicator and provide the person with a practical tip that is related to the consumed food or a goal that the person desires to achieve. In one example, if the person's goal is to lose weight and the person ate a piece of chocolate cake, the App and/or the programmed computer system of the instant invention can provide an active link from the graphical indicator or the area around the graphical indicator to a practical tip about a substitute food with less ED than the piece of chocolate cake.

Examples of Visually Tracking the Actual RCV(t), the Actual RCAV(t), the Potential RCV(T), and/or the Potential RCAV(t) Based on FED

In some embodiments, the instant invention visually tracks the actual/potential RCV(t) (FED) value of food servings consumed and/or contemplated to be consumed by the person. In some embodiments, the instant invention visually tracks actual/potential RCV(t) (FED) value of food servings consumed and/or contemplated to be consumed by the person in accordance with, but not limited to, the following equation:

RCV(t)(FED)=(FED(1)of food serving(1)/factor data(“FAC”)+FED(2)of food serving(2)/FAC+ . . . +FED(n)of food serving(n)/FAC) (2);

where the targeted optimum/desired range/value shown at a particular time is representative of a portion of PWNB attributed to a time from the beginning of the tracking period to the particular time at which the actual/potential RCV(t) (FED) value is calculated. For example, if PWNB is 52, the tracking period is 48 hours, and the actual/potential RCV(t) (FED) value is calculated after 12 hours from the start of the tracking period, then the shown targeted optimum/desired range/value is 13-52/(48/12).

Food servings can be specified in various ways, and preferably in ways that are meaningful to consumers according to their local dining customs. Food servings may be specified by weight, mass, size or volume, or according to customary ways of consuming food in the relevant culture. For example, in the United States it is customary to use measures such as cups, quarts, teaspoons, tablespoons, ounces, pounds, or even a “pinch”, in Europe, it is more common to use units such as liters, deciliters, grams and kilograms. In China and Japan it is also appropriate to use a measure such as a standard mass or weight held by chopsticks when consuming food.

In certain embodiments, food energy data is produced based on protein energy data representing the protein energy content, carbohydrate energy data representing the carbohydrate energy content and fat energy data representing the fat energy content, of a candidate food serving, by applying respective weight data to weight each of the protein energy data, the carbohydrate energy data and the fat energy data, each of the weight data representing the relative metabolic conversion efficiency of the corresponding nutrient and forming the food energy data based on a sum of the weighted protein energy data, the weighted carbohydrate energy data and the weighted fat energy data. The data for the various nutrients is provided either by the consumer or by another source based on data from the consumer, such as food identification data. If the protein energy data is represented as “PRO”, the carbohydrate energy data as “CHO” and the fat energy data as “FAT”, in certain ones of such embodiments, the food energy data (represented as “FED”) is obtained by processing the data in the manner represented by the following equation:

FED=(Wpro×PRO)+(Wcho×CHO)+(Wfat×FAT), (3)

where Wpro represents the respective weighting data for PRO, Wcho represents the respective weighting data for CHO and Wfat represents the respective weighting data for FAT. In certain ones of such embodiments, Wpro is selected from the range 0.7.1<Wpro<0.8, Wcho is selected from the range 0.9<Wcho<0.95 and Wfat is selected from the range 0.97<Wfat<1.0. In certain ones of such embodiments, Wpro is substantially equal to 0.8, Wcho is substantially equal to 0.95 and Wfat is substantially equal to 1.0. Various measures of energy can be employed, such as kilocalories (kcal) and kilojoules (kJ).

In certain embodiments, food energy data is produced based on protein data representing the mass or weight of the protein content (represented as PROm), carbohydrate data representing the mass or weight of the carbohydrate content (represented as CHOm) and fat data representing the mass or weight of the fat content (represented as FATm), of a candidate food serving. In such embodiments, the protein data, carbohydrate data and fat data are converted to energy data in producing the food energy data, by processing the protein data, carbohydrate data and fat data in the manner represented by the following equation:

FED=(Wpro×Cp×PROm)+(Wcho×Cc×CHOm)+(Wfat×Cf−×FATm), (4)

where Cp is a conversion factor for converting PROm to data representing the energy content of PROm, Cc is a conversion factor for converting CHOm to data representing the energy content of CHOm, and Cf is a conversion factor for converting FATm to data representing the energy content of FATm. For example where the food energy data is represented in kilocalories and PROm, CHOm and FATm are expressed in grams, Cp is selected as 4 kilocalories/gram, Cc is selected as 4 kilocalories/gram and Cf is selected as 9 kilocalories/gram. Mass and weight data can be expressed in the alternative by units such as ounces and pounds.

In certain embodiments, food energy data is produced based on total food energy data representing the total energy content, protein energy data representing the protein energy content, and dietary fiber energy data representing the dietary fiber energy content, of a candidate food serving. More specifically, the food energy data is produced by separating data representing the protein energy content and the dietary fiber energy content (if present) from the total food energy data to produce reduced energy content data, applying respective weight data to weight each of the protein energy data and the dietary fiber energy data, each of the weight data representing the relative metabolic conversion efficiency of the corresponding nutrient and forming the food energy data based on a sum of the reduced energy content data, the weighted protein energy data, and the weighted dietary fiber energy data. The data for the various nutrients is provided either by the consumer or by another source based on data from the consumer, such as food identification data. If the total food energy data is represented as “TFE”, protein energy data is represented as “PRO” and the dietary fiber energy data as “DF”, in certain ones of such embodiments where TFE includes an energy component of DF (as in the case of foods labeled according to practices adopted in the US and in the Dominion of Canada (CA)), the food energy data is obtained by processing, the data in the manner represented by the following equation:

FED=(TFE−PRO−DF)+(Wpro×PRO)+(Wdf×DF), (5)

where Wpro represents the respective weighting data for PRO and Wdf represents the respective weighting data for DF. In certain ones of such embodiments, Wpro is selected from the range 0.7≦Wpro≦0.8 and Wdf is selected from the range 0<Wdf<0.5. In certain ones of such embodiments, Wpro is substantially equal to 0.8 and Wdf is substantially equal to 0.25. Various measures of energy can be employed, such as kilocalories (kcal) and kilojoules (kJ).

For those instances where TFE does not include a dietary fiber component (as in the case of foods labeled according to practices adopted in Australia (AU) and the countries of central Europe (CE)), the process of equation (3) is modified to the following form:

FED=(TFE−PRO)+(Wpro×PRO)+(Wdf×DF). (6)

In certain embodiments, food energy data is produced based both on the total food energy data, as well as on protein data representing the mass or weight of the protein content (represented as PROm) and dietary fiber data representing the mass or weight of the dietary fiber content (represented as DFm), of a candidate food serving. In such embodiments and for foods labeled as in the US and CA, the protein data and dietary fiber data are converted to energy data in producing the food energy data, by processing the total food energy data, the protein data and dietary fiber data in the manner represented by the following equation:

FED=[TFE−(Cp×PROm)−(Cdf×DFm)]+(Wpro×Cp×PROm)+(Wdf×Cdf×DFm), (7)

where Cp is a conversion factor for converting PROm to data representing the energy content of PROm and Cdf is a conversion factor for converting DFm to data representing an energy content of DFm. For example where the food energy data is represented in kilocalories and PROm and DFm are expressed in grams, Cp is selected as 4 kilocalories/gram and Cdf is selected as 4 kilocalories/gram. Mass and weight data can be expressed in the alternative by units such as ounces and pounds.

For those instances where TFE does not include a dietary fiber component (as in the case of foods labeled according to practices adopted in AU and CE), the process of equation (5) is modified to the following form:

FED=[TFE−(Cp×PROm)]+(Wpro×Cp×PROm)+(Wdf×Cdf×DFm). (8)

In certain embodiments, food energy data is produced based on protein data representing the protein energy content of a candidate food serving, carbohydrate data representing its carbohydrate energy content, fat data representing its fat energy content, and dietary fiber data representing its dietary fiber energy content. This data is provided either by the consumer or from another source based on data from the consumer, such as food identification data. If the protein energy data is represented as “PRO”, the carbohydrate energy data as “CHO”, the fat energy data as “FAT”, and the dietary fiber energy data as “DF”, in certain ones of such embodiments, the food energy data (represented as “FED”) is obtained by processing the data in the manner represented by the following equation:

FED=PRO+CHO+FAT+DF. (9)

In certain ones of such embodiments, food energy data is produced based on the protein energy data, the carbohydrate energy data, the fat energy data, and the dietary fiber energy data, of the candidate food serving, by applying respective weight data to weight each of the protein energy data, the carbohydrate energy data, the fat energy data and the dietary fiber energy data representing its relative metabolic conversion efficiency and forming the food energy data based on a sum of the weighted protein energy data, the weighted carbohydrate energy data, the weighted fat energy data and the weighted dietary fiber energy data. If Wpro represents the respective weighting data for PRO, Wcho represents the respective weighting data for CHO, Wfat represents the respective weighting data for FAT and Wdf represents the respective weighting data for dietary fiber, in certain ones of such embodiments, the food energy data (represented as “FED”) is obtained by processing the data in the manner represented by the following equation:

FED=(Wpro×PRO)+(Wcho×CHO)+(Wfat×FAT)+(Wdf×DF). (10)

In certain ones of such embodiments, Wpro is selected from the range 0.7≦Wpro≦0.8, Wcho is selected from the range 0.9≦Wcho≦0.95, Wfat is selected from the range 0.97≦Wfat≦1.0 and Wdf is selected from the range 0<Wdf≦0.5 In certain ones of such embodiments, Wpro is substantially equal to 0.8, Wcho is substantially equal to 0.95, Wfat is substantially equal to 1.0 and Wdf is substantially equal to 0.25.

In certain embodiments, food energy data is produced based on protein data representing the mass or weight of the protein content (represented as PROm), carbohydrate data representing the mass or weight of the carbohydrate content (represented as CHOm), fat data representing the mass or weight of the fat content (represented as FATm) and dietary fiber data representing the mass or weight of the dietary fiber content (represented as DFm), of a candidate food serving. In such embodiments, the protein data, carbohydrate data, fat data and dietary fiber data, are converted to energy data in producing the food energy data, by processing the protein data, carbohydrate data, fat data and dietary fiber data in the manner represented by the following equation:

FED=(Wpro×Cp×PROm)+(Wcho×Cc×CHOm)+(Wfat×Cf×FATm)+(Wdf×Cdf×DFm), (11)

where Cp is a conversion factor for converting PROm to data representing an energy content of PROm, Cc is a conversion factor for converting CHOm to data representing an energy content of CHOm, Cf is a conversion factor for converting FATm to data representing an energy content of FATm and Cdf is a conversion factor for converting DFm to data representing an energy content of DFm. For example where the food energy data is represented in kilocalories and PROm, CHOm, FATm and DFm are expressed in grams, Cp is selected as 4 kilocalories/gram, Cc is selected as 4 kilocalories/gram, Cf is selected as 9 kilocalories/gram and Cdf is selected as 4 kilocalories/gram.

In the US and in CA, where food labeling standards include a food product's dietary fiber in its total carbohydrate amount in grams (represented as “Total_CHOm” herein), food energy data may instead be produced by processing the protein data, carbohydrate data, fat data and dietary fiber data in the manner represented by the following equation:

FED=(Wpro×Cp×PROm)+(Wcho×Cc×[Total_CHOm−DFm])+(Wfat×Cf×FATm)+(Wdf×Cdf×DFm). (12)

In certain embodiments, the food energy data is produced in a modified fashion in order to discourage consumption of foods having a high saturated fat content, so that the food energy data (FED) is based both on the relative metabolic conversion efficiency of selected nutrients and weighting data that promotes consumption of relatively more healthful foods. In such embodiments, and where (as in the US and CA) food labeling standards include a food product's saturated fat (represented as “Sat_FATm” herein) in its total amount of fat in grams (represented as “Total_FATm” herein), the food energy data is produced by processing the protein data, carbohydrate data, fat data, saturated fat data and dietary fiber data in the manner represented by the following equation:

FED=(Wpro×Cp×PROm)+(Wcho×Cc×[Total_CHOm−DF−m])+(Wdf×Cdf×DFm)+(Wfat×Cf×[Total_FATm−Sat_FATm])+−(Wsfat×Cf×Sat_Fatm), (13)

wherein Wsfat represents modified weighting data for Sat_FATm. In certain ones of such embodiments, Wpro is selected from the range 0.7≦Wpro≦0.8, Wcho is selected from the range 0.9≦Wcho≦0.95, Wfat is selected from the range 0.97≦Wfat≦1.0, Wdf is selected from the range 0<Wdf≦0.5, and Wsfat is selected from the range 1.0≦Wsfat≦1.3. In particular ones of such embodiments, Wpro is substantially equal to 0.8, Wcho is substantially equal to 0.95, Wfat is substantially equal to 1.0, Wdf is substantially equal to 0.25 and Wsfat is substantially equal to 1.3.

The relatively higher value assigned to Wsfat is based, in part, on the desirability of discouraging consumption of saturated fat, due to the ill-health effects associated with this nutrient. The higher ranges and values of Wpro and Wcho in the presently disclosed embodiments relative to those employed in embodiments disclosed hereinabove, are useful for weight loss processes. That is, consumers engaged in a weight loss process by limiting their food energy consumption could, in some cases, be encouraged to eat foods higher in saturated fat if it is assigned a relatively higher weight than other nutrients, since this tends to reduce their overall food energy consumption. By assigning relatively higher ranges and values for Wpro and Wcho for use in processes that also weight saturated fat higher than unsaturated fat, the potential to encourage consumption of saturated fat is substantially reduced. Accordingly, the weights assigned to Wpro and Wcho in the presently disclosed embodiments are based both on the relative metabolic conversion efficiency of protein and carbohydrates and the desire to promote consumption of relatively more healthful foods.

In certain embodiments, for foods containing alcohol, the foregoing processes as represented by equation (11) are modified to add a term representing an energy component represented by the amount of alcohol in the food. Where the amount of alcohol (by weight or mass) is expressed in grams (represented as “ETOHm” herein), this term is produced by multiplying ETOHm by a weighting factor Wetoh and a conversion factor Cetoh, where Wetoh is selected from the range 1.0≦Wetoh≦1.3, and in particular ones of such embodiments is substantially equal to 1.29, and Cetoh is selected as 9 kilocalories/gram, based on the principle that alcohol is metabolized in the same pathway as fat. The higher value assigned to Wetoh is based, in part, on the desirability of discouraging consumption of alcohol, due to the ill-health effects associated with this nutrient. Where a food contains alcohol, in certain embodiments its food energy data is produced by processing PROm, Total_CHOm, DFm, Total_FATm, Sat_FATm, and ETOHm in the manner represented by the following equation:

FED=(Wpro×Cp×PROm)+(Wcho×Cc×[Total_CHOm−DFm])+(Wdf×Cdf×DFm)+(Wfat×Cf×[Total_FATm−Sat_FATm])+−(Wsfat×Cf×Sat_Fatm)+(Wetoh×Cetoh×ETOHm). (14)

The process represented by equation (12) is modified for use in CE and AU and is represented as follows:

FED=(Wpro×Cp×PROm)+(Wcho×Cc×Total_CHOm)+(Wdf×Cdf×DFm)+(Wfat×Cf×[Total_FATm−Sat_FATm])+(Wsfat×Cf×Sat_FATm)+(Wetoh×Cetoh×ETOHm). (15)

In certain embodiments, for foods containing sugar alcohol, the foregoing processes as represented by equations (12) and (13) are modified to add a term representing an energy component represented by the amount of sugar alcohol in the food. Where the amount of sugar alcohol (by weight or mass) is expressed in grams (represented as “SETOHm” herein), this term is produced by multiplying SETOHm by a weighting factor Wsetoh and a conversion factor Csetoh, where Wsetoh is selected from the range 0.9≦Wsetoh≦0.95, and in particular ones of such embodiments is substantially equal to 0.95, and Csetoh is selected from the range 0.2 to 4.0 kilocalories/gram, and in particular ones of such embodiments is substantially equal to 2.4. Where a food contains sugar alcohol, in certain embodiments its food energy data is produced by processing PROm, Total_CHOm, DFm, Total_FATm, Sat_FATm, ETOHm and SETOHm in the manner represented by the following equation:

FED=(Wpro×Cp×PROm)+(Wcho×Cc×[Total_CHOm−DFm−SETOHm])+(Wdf×Cdf×DFm)+(Wfat×Cf×[Total_FATm−Sat_−FATm])+(Wsfat×Cf×Sat_Fatm)+(Wetoh×Cetoh×ETOHm)+(Wsetoh×Csetoh×SETOHm). (16)

The process represented by equation (14) is modified for use in CE and AU and is represented as follows:

FED=(Wpro×Cp×PROm)+(Wcho×Cc×[Total_CHOm−SE−TOHm])+(Wdf×Cdf×DFm)+(Wfat×Cf×[Total_FATm−Sat_FATm])+(Wsfat×Cf×Sat_Fatm)+(Wetoh×Cetoh×ETOHm)+(Wsetoh×Csetoh×SETOHm). (17)

For the person's convenience, the food energy data is converted to simplified whole number data for a candidate food serving by producing dietary data expressed as whole number data by dividing the food energy data by factor data, such as data having a value of 35, and rounding the resulting value to produce the simplified whole number data. (Of course, to assign 35 as the value of the factor data is arbitrary, and any other value such as 50, 60 or 70 may be used for this purpose.)

In the manner described above, the consumer can easily track food consumption throughout a period, such as a day or a week, (either manually or with the assistance of a data processing system) to ensure that a pre-determined sum of the dietary data for the food consumed bears a pre-determined relationship to a value of pre-determined whole number benchmark data based on one or more of the consumer's age, body weight, height, gender and activity level. For example, if the consumer is following a weight loss program, the pre-determined whole number benchmark data is set at a value selected to ensure that the consumer will lose weight at a safe rate if he or she consumes an amount of food during the period having a sum of dietary data that does not exceed the pre-determined whole number benchmark data.

Since individual food energy needs vary with the individual's age, weight, gender, height and activity level, in certain embodiments the pre-determined whole number benchmark data is selected based on one or more of these variables. In such embodiments, food energy needs are estimated based on methods published by the National Academies Press, Washington, D.C., USA in Dietary Reference Intakes for Energy, Carbohydrates, Fiber, Fat, Fatty Acids, Cholesterol, Protein and Amino Acids, 2005, pages 203 and 204. More specifically, as explained therein these methods estimate that men aged 19 years and older have a total energy expenditure (TEE) determined as follows:

TEE=864−(9.72×age)+PA×(14.2×weight+503×height), (18)

and that women aged 19 years and older have a TEE determined as follows:

TEE=387−(7.31×age)+PA×(10.9×weight+660.7×height), (19)

where age is given in years, weight in kilograms and height in meters.

In such embodiments, these methods are employed on the basis that all individuals have a “low active” activity level, so that the activity level (PA) for men is set at 1.12 and PA for women is set at 1.14. The published methods assume a 10 percent conversion cost regardless of the types and amounts of nutrients consumed; consequently, TEE is adjusted by subtracting 10 percent of the calculated TEE. Also, the published method of calculating TEE assigns an energy content of zero to certain foods having a non-zero energy content. The total energy content of such foods consumed within a given day generally falls within a range of 150 to 250 kilocalories, which may be normalized as 200 kilocalories. Accordingly, TEE as determined by the published method is adjusted to produce adjusted TEE (ATEE) in a process represented by the following equation:

ATEE=TEE−(TEE×0.10)+200, (20)

where ATEE and TEE are given in kilocalories.

For consumers carrying out a process of reducing body weight, the pre-determined whole number benchmark is obtained by subtracting an amount from the adjusted TEE selected to ensure a pre-determined weight loss over a pre-determined period of time. For example, a safe weight loss process can be selected to produce a loss of two pounds per week, or a consumption of 1000 kilocalories per day less than ATEE for a given individual. In this example, to produce the pre-determined whole number benchmark data (PWNB), where the factor data used to produce the dietary data for the candidate food servings (whether having a value of 35, 50, 60, 70 or other value) is represented as FAC, such data is produced by a process represented by the following equation:

PWNB=(ATEE−1000)/FAC. (21)

To achieve weight loss, the value of (ATEE−1000) in certain embodiments is selected to fall within a range of 1000 kilocalories to 2500 kilocalories, so that if (ATEE-1000) is less than 1000 kilocalories, then (ATEE is set equal to 1000 kilocalories, and if (ATEE−1000) is greater than 2500 kilocalories, (ATEE−1000) is set equal to 2500 kilocalories. However, in various other embodiments, the upper limit of 2500 kilocalories varies from 2000 to 3000 kilocalories, and the lower limit of 1000 kilocalories varies from 500 to 1500 kilocalories.

Examples of Visually Tracking the Actual RCV(t), the Actual RCAV(t), the Potential RCV(t), and/or the Potential RCAV(t) Based on HD

In some embodiments, the instant invention visually tracks actual/potential RCAV(t) (HD) value of food consumed or contemplated to be consumed by the person. In some embodiments, the instant invention visually tracks actual/potential RCV(t) (HD) value of the person based on food servings in accordance with, but not limited to, the following equation:

RCV(t)(HD)=(HD(1)of food(1)+HD(2)of food(2)+ . . . +HD(n)of food(n)) (22);

where RCV(t) (HD) is visually compared to the targeted optimum/desired range/value of HD shown. In some embodiments, the targeted optimum/desired range/value of HD is determined based on one or more groups of food considered to be most healthful for the person to consume.

In certain embodiments, the relative healthfulness data is determined in a manner that depends on a particular food group of the selected food. In certain ones of such embodiments, the healthfulness data is determined in a first, common manner for foods within a first metagroup comprising the following groups: beans, dry & legumes; and oils. The healthfulness data (HD) for these groups is obtained based on a linear combination of fat content data, saturated fat content data, sugar content data and sodium content data for the food. In one such embodiment, the healthfulness data is produced by processing fat content data (F_data), saturated fat content data (SF_data), sugar content data (S_data) and sodium content data (NA_data), as follows, wherein such data is determined as explained hereinbelow:

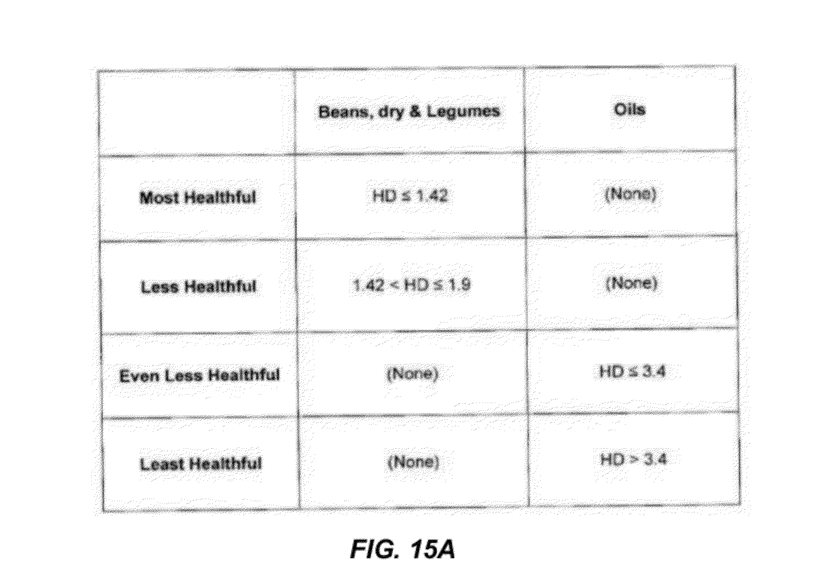

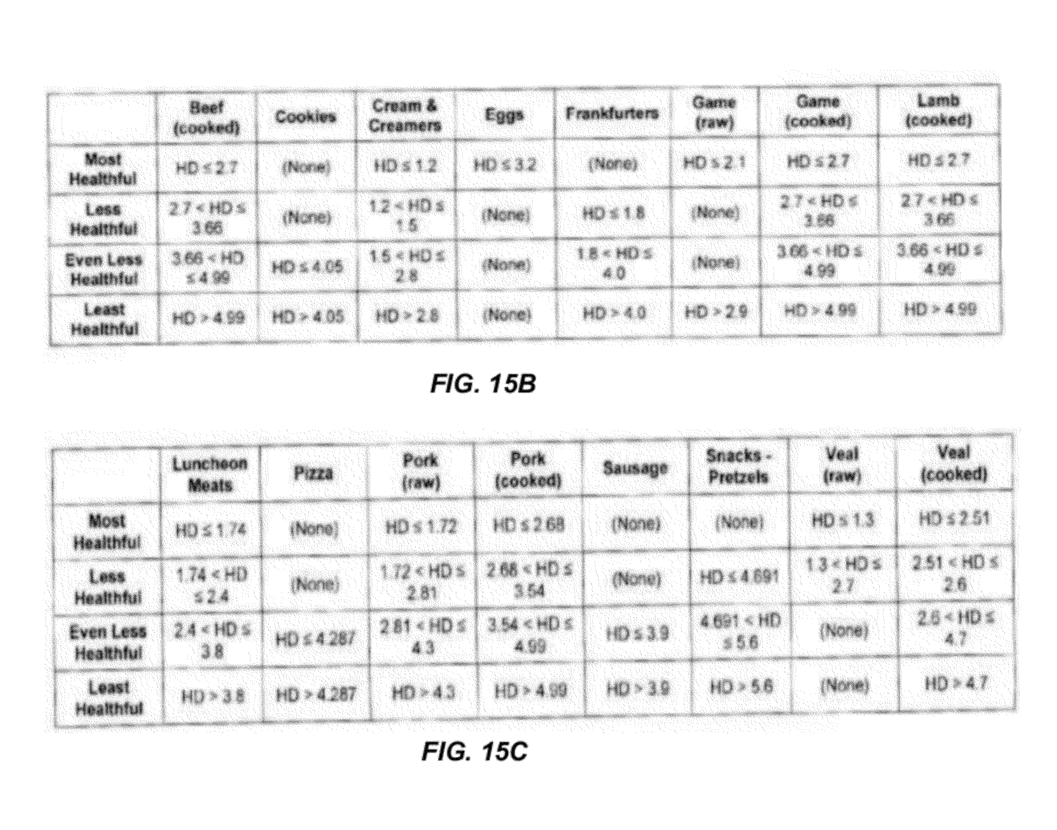

HD=[(2×(SF_data+F_data)+S_data+NA_data]/4/kcal_DV (23)

where kcal_DV is determined as explained hereinbelow. The table of FIG. 15A illustrates how the foods in these groups are ranked according to their healthfulness based on their respective healthfulness data produced in accordance with the process represented by, for example, the equation (20) and a comparison thereof against the exemplary comparison data included therein. These values may be varied from place to place, from culture to culture and from time to time, to provide a fair comparison of available foods and food products.

It will also be appreciated that the food groups and metagroups, and the corresponding procedures and comparison values, as disclosed herein may be varied based on variations in the foods and food products available from place to place, culture to culture and over time. They may also vary to accommodate the needs and desires of certain segments of the population, such as those with special needs (for example, diabetic patients and those living in extreme climates) and those with particular healthfulness goals (which can vary, for example, with physical activity level). Such groups, metagroups, procedures, and comparison values are selected based on the similarities of foods and the manner in which related foods vary in the amounts and types of nutrients that tend to affect their healthfulness.

The value selected for kcal_DV is selected to represent a daily calorie value that depends on the purposes or needs of the class of consumers for whom the relative healthfulness data is provided. For example, if this class encompasses individuals desiring to loose body weight, the value of kcal_DV is selected as a daily calorie target to ensure weight loss, such as 1500 kcal. However, this value may differ from culture to culture and from country to country. For example, the energy needs of those living in China are generally lower than those living in the United States, so that kcal_DV may be selected at a lower value for Chinese individuals trying to reduce body weight than for those living in the United States. As a further example, if the class of consumers for whom the relative healthfulness data is provided encompasses athletes attempting to maintain body weight during training, kcal_DV may be set at a much higher level than 1500 kcal. For most purposes, kcal_DV may be selected in a range from 1000 kcal to 3000 kcal.

The value of SF_data is determined relative to a recommended or otherwise standardized limit on an amount or proportion of saturated fat to be included in a person's daily food intake. The recommended or otherwise standardized amount or proportion of saturated fat to be consumed daily is based on the person's presumed total food energy intake daily, and a proportion thereof represented by saturated fat. In certain embodiments, for consumers desiring to lose body weight, as explained hereinabove, a total food energy intake of 1500 kcal is assumed (although the amount may vary in other embodiments). If, for example, a maximum desirable percentage of saturated fat consumed as a proportion of total daily energy intake is assumed to be seven percent, then the total number of calories in saturated fat that the person consumes daily on such a diet should be limited to about 105 kcal (of a total of 1500 kcal). Since fat contains about nine kcal per gram, the person's daily consumption of saturated fat in this example should be limited to about twelve grams. However, the recommended or standardized limit on the proportion or amount of saturated fat to be consumed may vary from one class of consumer to another, as well as from country to country and from culture to culture. SF_data is determined by comparison to such a standard. In this example, therefore, SF_data is determined as the ratio of (a) the mass of saturated fat in a standard amount of the food under evaluation, to (b) twelve grams. While a different procedure or other amounts or proportions may be employed in other embodiments to evaluate the saturated fat content of a food, it is desired to determine SF_data in a manner that is reasonably comparable to the ways in which F_data, S_data and NA_data are determined.

Similarly to SF_data, the value of F_data is determined relative to a recommended or otherwise standardized limit on the amount or proportion of total fat to be included in a person's daily food intake. In those embodiments in which it is presumed that a person consumes 1500 kcal daily and a recommended proportion or limit of thirty percent of energy consumption in the form of fat is adopted, this translates to fifty grams of total fat on a daily basis. In this example, therefore, and in particular for comparability to SF_data, F_data is determined as the ratio of (a) the mass of total fat in a standard amount of the food under evaluation, to (b) fifty grams. Of course, a different procedure or other amounts or proportions may be employed in other embodiments to evaluate the total fat content of a food.

In a similar manner, the value of S_data is determined relative to a recommended or otherwise standardized limit on the amount or proportion of sugar to be included in a person's daily food intake. In those embodiments in which it is presumed that a person consumes 1500 kcal daily and a recommended proportion or limit of ten percent of food energy intake in the form of sugar is adopted, this translates to thirty eight grams of sugar on a daily basis (at four kcal per gram of sugar). In this example, therefore, and in particular for comparability to SF_data and F_data, S_data is determined as the ratio of (a) the mass of sugar in a standard amount of the food under evaluation, to (b) thirty eight grams. Of course, a different procedure or other amounts or proportions may be employed in other embodiments to evaluate the sugar content of a food.

In a manner similar to those described above, the value of NA_data is determined relative to a recommended or otherwise standardized limit on the amount or proportion of sodium to be included in a person's daily food intake. In those embodiments in which a recommended limit of 2400 mg of sodium consumed daily is adopted, NA_data is determined as the ratio of (a) the mass of sodium in a standard amount of the food under evaluation, to (b) 2400 mg. Of course, a different procedure or other amounts or proportions may be employed in other embodiments to evaluate the sodium content of a food.

In such embodiments, the healthfulness data is determined in a second, common manner for foods within a second metagroup comprising the following groups: beef (cooked), cookies, cream & creamers, eggs, frankfurters, game (raw), game (cooked), lamb (cooked), luncheon meats, pizza, pork (raw), pork (cooked), sausage, snacks—pretzels, veal (raw) and veal (cooked). The healthfulness data (HD) for these groups is obtained based on a linear combination of the food's fat content data, saturated fat content data, sugar content data, sodium content data and ED data. In one such embodiment, the healthfulness data is produced by processing F_data, SF_data, S_data, NA_data and ED_data of the food, as follows, wherein F_data, SF_data, S_data and NA_data are obtained as explained hereinabove:

HD=ED_data+([(2×SF_data)+(2×F_data)+NA_data+S_data]×100/M_serving), (24)

where M_serving is the mass or weight of a standard serving of the food. In this particular embodiment, ED_data is obtained as the energy content of the food (in kcal) divided by its mass (in grams). The tables of FIGS. 15B and 15C illustrate how the foods in these groups are ranked according to their healthfulness based on their respective healthfulness data produced in accordance with the process represented by equation (21) and a comparison thereof against the exemplary comparison data included therein.

In such embodiments, the healthfulness data is determined in a third, common manner for foods within a third metagroup comprising the following groups: beverages; alcoholic beverages; sweet spreads—jams, syrups, toppings & nut butters. The healthfulness data (HD) for these groups is obtained based on a linear combination of the food's fat content data, saturated fat content data, sugar content data, sodium content data and ED data. In one such embodiment, the healthfulness data is produced by processing F_data, SF_data, S_data, NA_data, ED_data and M_serving, as follows:

HD=(ED_data/3)+[(2×SF_data)+(2×F_data)+(2×S_data)+NA_data]/M_serving. (25)

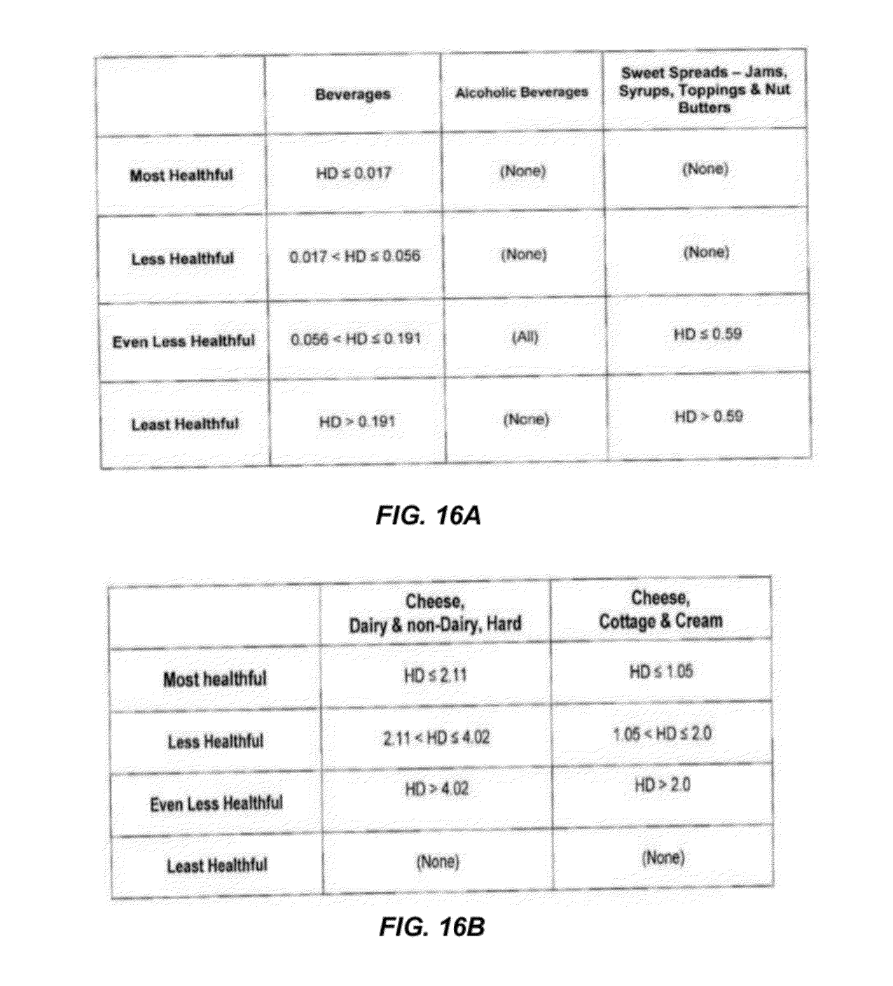

The table of FIG. 16A illustrates how the foods in these groups are ranked according to their healthfulness based on their respective healthfulness data produced in accordance with the process represented by equation (22) and a comparison thereof against the exemplary comparison data included therein.

In such embodiments, the healthfulness data is determined in a fourth, common manner for foods within a fourth metagroup comprising the following groups: cheese, dairy & non-dairy, hard; and cheese, cottage & cream. The healthfulness data (HD) for these groups is obtained based on a linear combination of the food's fat content data, saturated fat content data, sugar content data, sodium content data and ED data. In one such embodiment, the healthfulness data is produced by processing F_data, SF_data, S_data, NA_data, ED_data and M_serving, as follows:

HD=ED_data+[(4×SF_data)+(4×F_data)+S_data+NA_data]×100−/M_serving. (26)

The table of FIG. 16B illustrates how the foods in these groups are ranked according to their healthfulness based on their respective healthfulness data produced in accordance with the process represented by equation (23) and a comparison thereof against the exemplary comparison data included in FIG. 16B.

In such embodiments, the healthfulness data is determined in a fifth, common manner for foods within a fifth metagroup comprising the following groups: breads; bagels; tortillas, wraps; breakfast—pancakes, waffles, pastries; and vegetable dishes The healthfulness data (HD) for these groups is obtained based on a linear combination of the food's fat content data, saturated fat content data, sugar content data, sodium content data and ED data. In one such embodiment, the healthfulness data is produced by processing F_data, SF_data, S_data, NA_data, ED_data and M_serving, as follows:

HD=ED_data+[(2×SF_data)+F_data+S_data+(2×NA_data)−DF_data]×100/M_serving. (27)

The value of DF_data is determined relative to a recommended or otherwise standardized minimum amount or proportion of dietary fiber to be included in a person's daily food intake. One such recommendation is that a minimum of ten grams of dietary fiber be consumed by a person for every 1000 kcal consumed daily. In those embodiments in which it is presumed that a person consumes 1500 kcal daily, this translates to a recommended minimum of fifteen grams of dietary fiber on a daily basis. Of course, a different procedure or other amounts or proportions may be employed in other embodiments to evaluate the recommended amount of dietary fiber to be consumed on a periodic basis. In this particular example, the value of DF_data is obtained as the ratio of the mass of dietary fiber in a standard serving of then food, to fifteen grams.

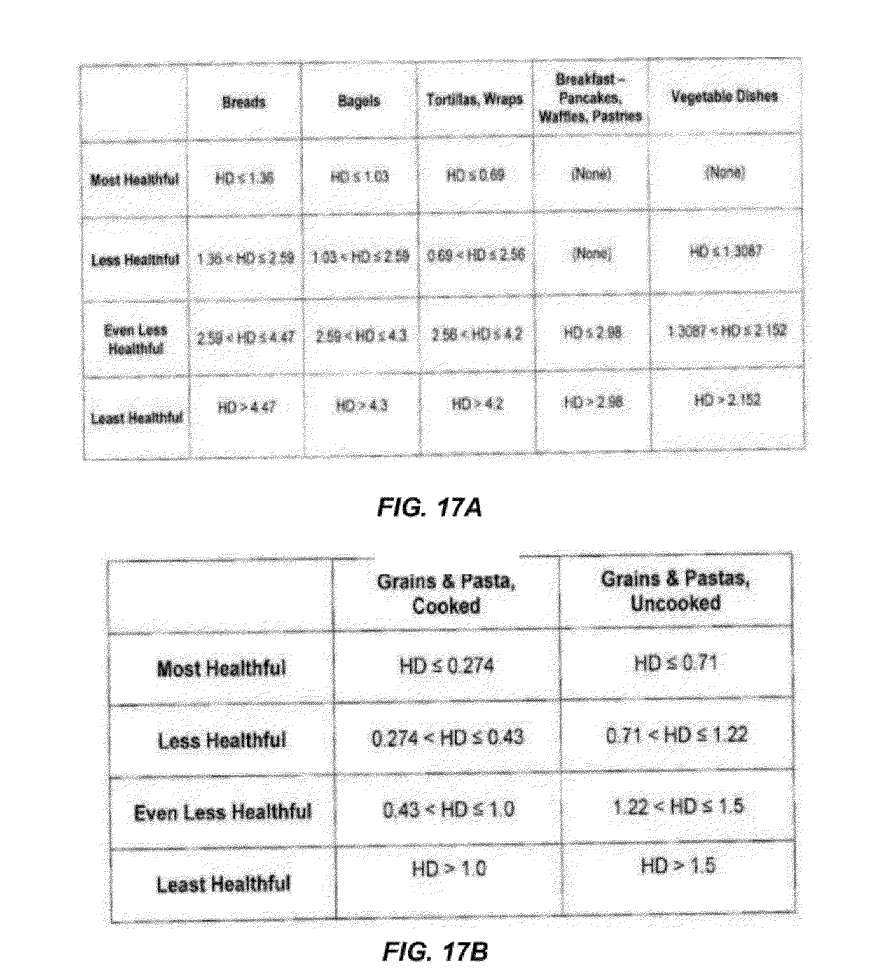

The table of FIG. 17A illustrates how the foods in these groups are ranked according to their healthfulness based on their respective healthfulness data produced in accordance with the process represented by equation (24) and a comparison thereof against the exemplary comparison data included in FIG. 17A.

In such embodiments, the healthfulness data is determined in a sixth, common manner for foods within a sixth metagroup comprising the following groups: grains & pasta, cooked; and grains & pasta, uncooked. The healthfulness data (HD) for these groups is obtained based on a linear combination of the food's fat content data, saturated fat content data, sugar content data, sodium content data, ED data and dietary fiber content data. In one such embodiment, the healthfulness data is produced by processing F_data, SF_data, S_data, NA_data, ED_data and DF_data, as follows:

HD=(ED_data/3)+[([SF_data+F_data+(2×S_data)+(2×NA_data)]/4)−DF_data]×100/M_serving. (28)

The table of FIG. 17B illustrates how the foods of the groups in the sixth metagroup are ranked according to their healthfulness based on their respective healthfulness data produced in accordance with the process represented by equation (25) and a comparison thereof against the exemplary comparison data included in FIG. 17B.

In such embodiments, the healthfulness data is determined in a seventh, common manner for foods within a seventh metagroup comprising the following groups: breakfast cereals, hot, cooked; breakfast cereals, hot, uncooked; and fruit salads. The healthfulness data (HD) for these groups is obtained based on a linear combination of the food's saturated fat content data, fat content data, sugar content data, sodium content data and ED data. In one such embodiment, the healthfulness data is produced by processing SF_data, F_data, S_data, NA_data and ED_data, as follows:

HD=ED_data+[SF_data+(2×F_data)+(2×S_data)+(2×NA_data]×100/M_serving. (29)

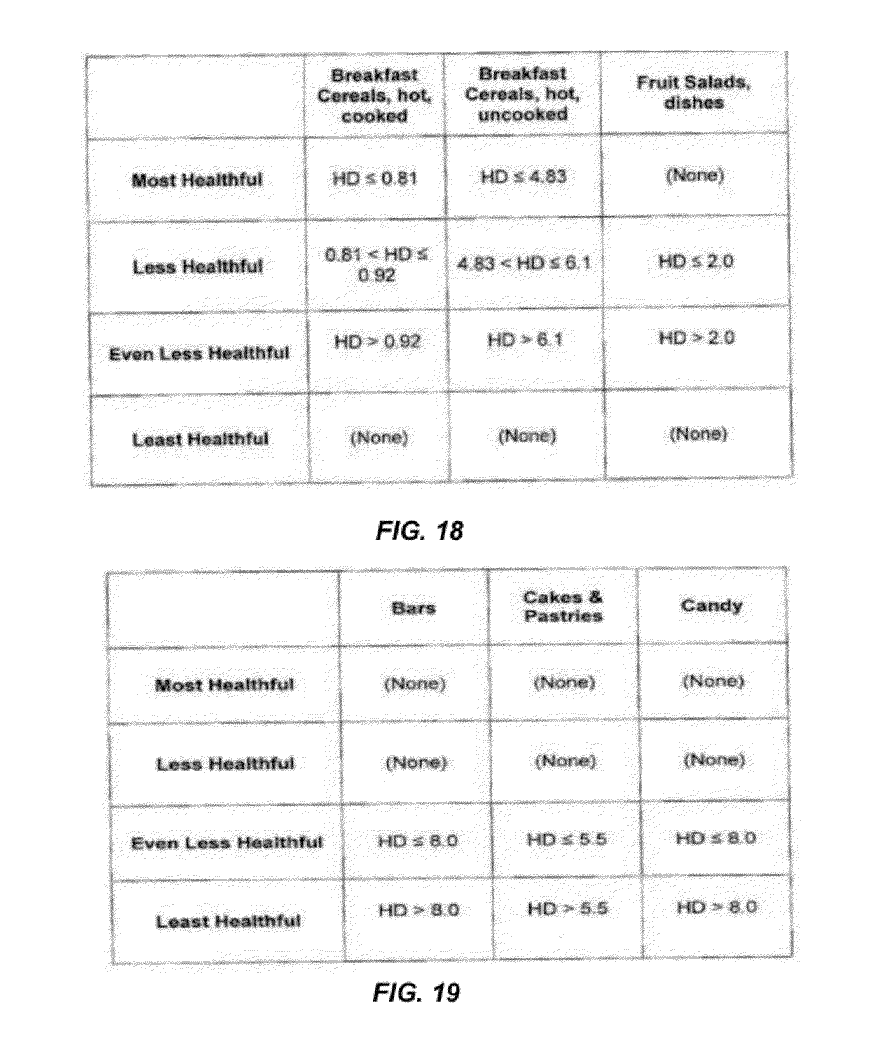

The table of FIG. 18 illustrates how the foods in these groups are ranked according to their healthfulness based on their respective healthfulness data produced in accordance with the process represented by equation (26) and a comparison thereof against the exemplary comparison data included in FIG. 18.

In such embodiments, the healthfulness data is determined in an eighth, common manner for foods within an eighth metagroup comprising the following groups: bars; cakes and pastries; and candy. The healthfulness data (HD) for these groups is obtained based on a linear combination of the food's fat content data, saturated fat content data, sodium content data, ED data and sugar content data. In one such embodiment, the healthfulness data is produced by processing F_data, SF_data, NA_data, ED_data and S_data, as follows:

HD=ED_data+[(2×SF_data)+F_data+(2×S_data)+(2×NA_data)]×100/M_serving. (30)

The table of FIG. 19 illustrates how the foods in these groups are ranked according to their healthfulness based on their respective healthfulness data produced in accordance with the process represented by equation (27) and a comparison thereof against the exemplary comparison data included in FIG. 19.

In such embodiments, the healthfulness data is determined in a ninth, common manner for foods within a ninth metagroup comprising the following groups: dips; dressings; gravies; sauces; soups, condensed; soups, RTE; and spreads (other than sweet). The healthfulness data (HD) for these groups is obtained based on a linear combination of the food's fat content data, saturated fat content data, sodium content data, sugar content data and ED data. In one such embodiment, the healthfulness data is produced by processing F_data, SF_data, S_data, NA_data, and ED_data, as follows:

HD=ED_data+[(2×SF_data)+F_data+S_data+(2×NA_data)]×100/M_serving. (31)

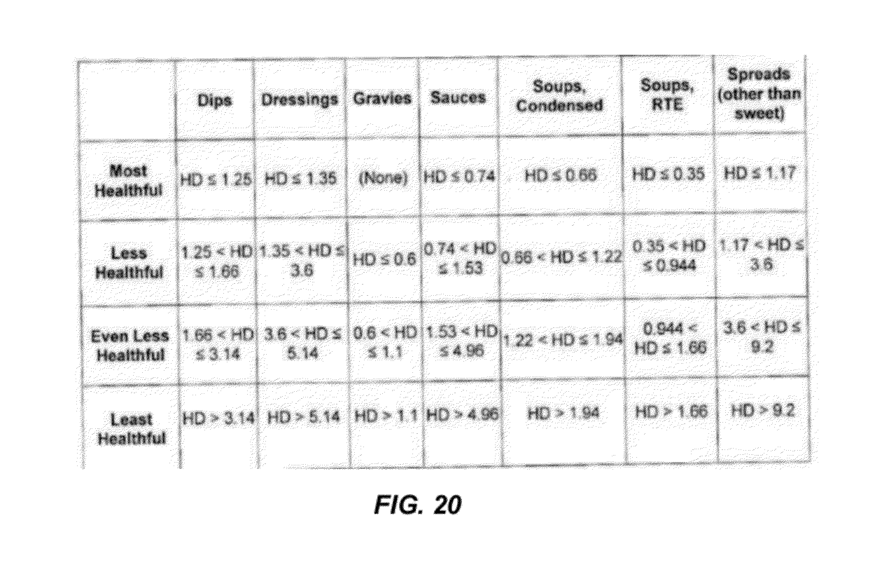

The table of FIG. 20 illustrates how the foods in these groups are ranked according to their healthfulness based on their respective healthfulness data produced in accordance with the process represented by equation (28) and a comparison thereof against the exemplary comparison data included in FIG. 20.

In such embodiments, the healthfulness data is determined in a tenth, common manner for foods within a tenth metagroup comprising the following groups: beans, dry & legumes dishes; beef dishes; breakfast mixed dishes; cheese dishes; chili, stew; egg dishes; fish & shellfish dishes; lamb dishes; pasta dishes; pasta, cooked; pork dishes; poultry dishes; rice & grains dishes; salads, main course; salads, side; sandwiches; veal dishes and vegetarian meat substitutes. The healthfulness data (HD) for these groups is obtained based on a linear combination of the food's fat content data, saturated fat content data, sodium content data, sugar content data and ED data. In one such embodiment, the healthfulness data is produced by processing F_data, SF_data, NA_data, S_data and ED_data, as follows:

HD=ED_data+[(2×SF_data)+(2×F_data)+S_data+(2×NA_data)]×100/M_serving. (32)

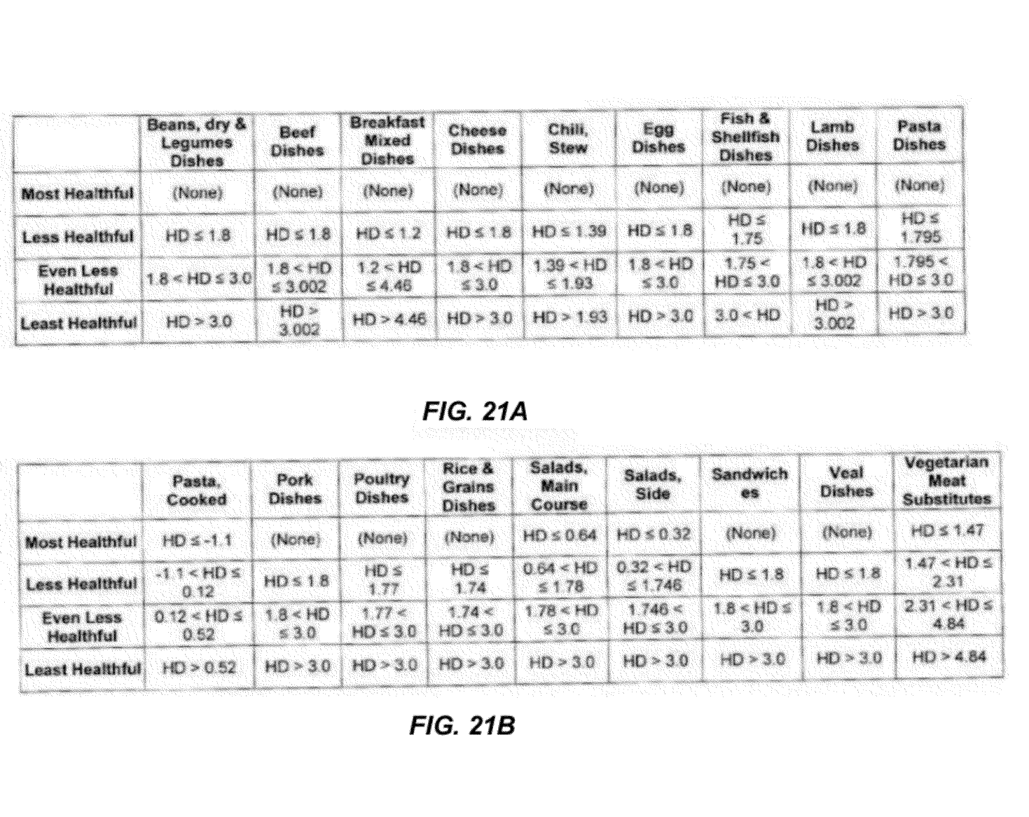

The tables of FIGS. 21A and 21B illustrate how the foods in these groups are ranked according to their healthfulness based on their respective healthfulness data produced in accordance with the process represented by equation (29) and a comparison thereof against the exemplary comparison data included in FIGS. 21A and 21B.

In such embodiments, the healthfulness data is determined in an eleventh, common manner for foods within an eleventh metagroup comprising the following groups: fruit—fresh, frozen & dried; and fruit & vegetable juices. The healthfulness data (HD) for these groups is obtained based on a linear combination of the food's sodium content data, sugar content data, saturated fat content data, fat content data and ED data. In one such embodiment, the healthfulness data is produced by processing NA_data, S_data, SF_data, F_data and ED_data, as follows:

HD=ED_data+[(2×S_data)+NA_data+SF_data+F_data]×100/M_serving. (33)

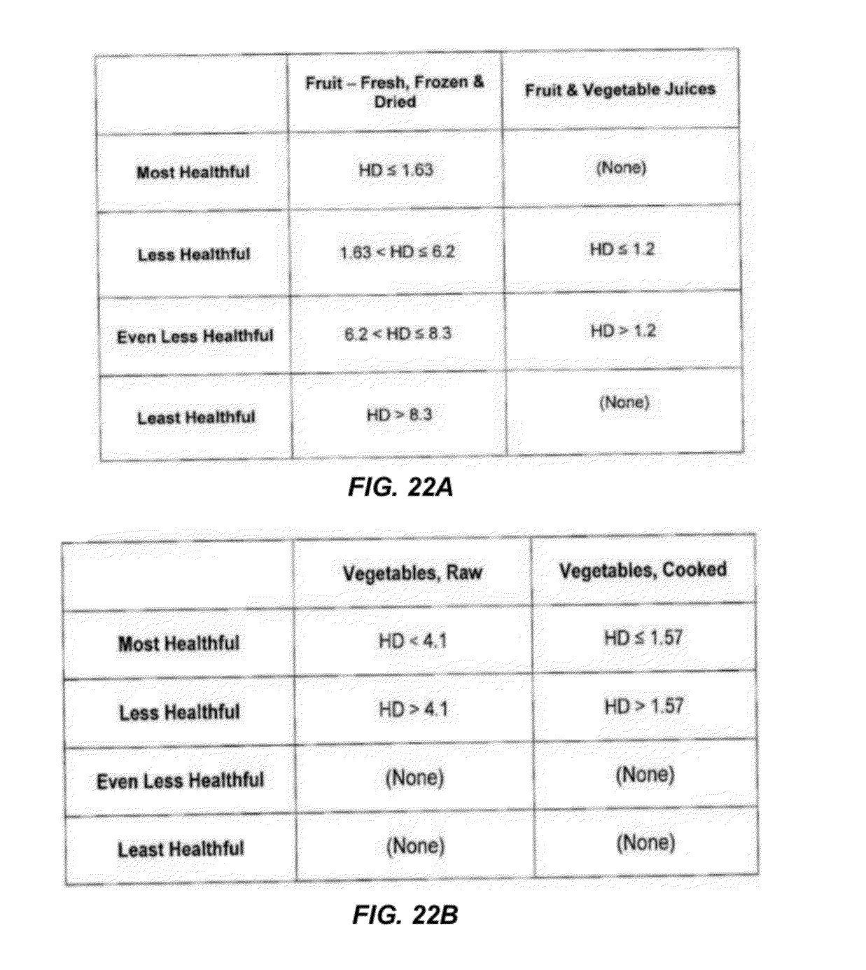

The table of FIG. 22A illustrates how the foods in these groups are ranked according to their healthfulness based on their respective healthfulness data produced in accordance with the process represented by equation (30) and a comparison thereof against the exemplary comparison data included in FIG. 22A.

In such embodiments, the healthfulness data is determined in a twelfth, common manner for foods within a twelfth metagroup comprising the following groups:

vegetables, raw; and vegetables, cooked. The healthfulness data (HD) for these groups is obtained based on a linear combination of the food's sodium content data, sugar content data, saturated fat content data, fat content data and ED data. In one such embodiment, the healthfulness data is produced by processing NA_data, S_data, SF_data. F_data and ED_data as follows:

HD=ED_data+[S_data+(1.5×NA_data)+(5×SF_data)+(5×F_data)]×100/M_serving. (34)

The table of FIG. 22B illustrates how the foods in these groups are ranked according to their healthfulness based on their respective healthfulness data produced in accordance with the process represented by equation (31) and a comparison thereof against the exemplary comparison data included in FIG. 22B.

In such embodiments, the healthfulness data is determined in a thirteenth, common manner for foods within a thirteenth metagroup comprising the following groups: gelatin, puddings; ice cream desserts; ice cream novelties; ice cream, sherbet, sorbet; sweet pies; and sweets—honey, sugar, syrup, toppings. The healthfulness data (HD) for these groups is obtained based on a linear combination of the food's sodium content data, fat content data, saturated fat content data, sugar content data, and ED data. In one such embodiment, the healthfulness data is produced by processing NA_data, F_data, SF_data, S_data, and ED_data, as follows:

HD=ED_data+[(2×SF_data)+F_data+NA_data+(2×S_data)]×100/M_serving. (35)

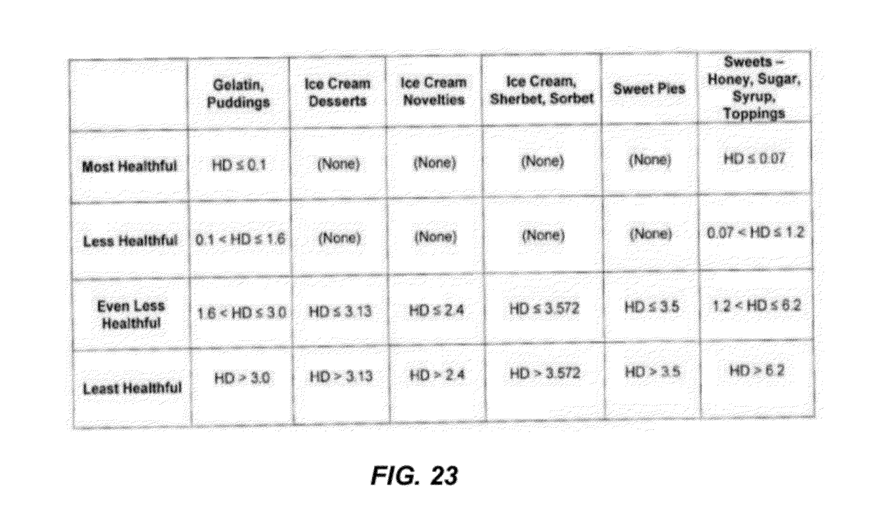

The table of FIG. 23 illustrates how the foods in these groups are ranked according to their healthfulness based on their respective healthfulness data produced in accordance with the process represented by equation (32) and a comparison thereof against the exemplary comparison data included in FIG. 23.

In such embodiments, the healthfulness data is determined in a fourteenth, common manner for foods within the following group: breakfast cereals, RTE. The healthfulness data (HD) for this group is obtained based on the saturated fat content data of the food, as well as its fat content data, sugar content data, sodium content data, dietary fiber content data and ED data. In one such embodiment, the healthfulness data is produced by processing SF_data, F_data, S_data, NA_data, DF_data and ED_data, as follows:

HD=(ED_data/3)+[(2×S_data)+SF_data+F_data+NA_data−DF_data]×100/M_serving. (36)

For this group, the most healthful foods have an HD value less than or equal to −0.36, while less healthful foods have an HD value greater than −0.36 and less than or equal to 1.66, even less healthful foods have an HD value greater than 1.66 and less than or equal to 2.91 and the most unhealthful foods have an HD value greater than 2.91.

In such embodiments, the healthfulness data is determined in a fifteenth, common manner for foods within an fifteenth metagroup comprising the following group: coffee/tea drinks with milk. The healthfulness data (HD) for this group is obtained based on the saturated fat content data, the fat content data, the sodium content data and the sugar content data of the food. In one such embodiment, the healthfulness data is produced by processing SF_data, F_data, S_data and NA_data, as follows:

HD=([(2×SF_data)+(2×F_data)+(2×S_data)+NA_data]/4)/kcal_DV. (37)

For this group, the most healthful foods have an HD value less than or equal to 3.25, while relatively less healthful foods have an HD value greater that 3.25 and less than or equal to 3.471, even less healthful foods have an HD value greater than 3.471 and less than or equal to 4.18 and the least healthful foods have an HD value greater than 4.18.

In such embodiments, the healthfulness data is determined in a sixteenth, common manner for foods within the following group: crackers. The healthfulness data (HD) for this group is obtained based on the saturated fat content data, the fat content data, the sugar content data, the sodium content data and the ED data of the food. In one such embodiment, the healthfulness data is produced by processing SF_data, F_data, S_data, NA_data and ED_data, as follows:

HD=(ED_data/3)+[(2×SF_data)+F_data+S_data+(2×NA_data)]×100/M_serving. (38)

For this group, none of the foods are graded in the most healthful foods category, while relatively less healthful foods have an HD less than or equal to 1.805, even less healthful foods have an HD value greater than 1.805 and less than or equal to 3.2, and the least healthful foods have an HD value greater than 3.2.

In such embodiments, the healthfulness data is determined in a seventeenth, common manner for foods within the following group: fish, cooked. The healthfulness data (HD) for this group is obtained based on the saturated fat content data, the fat content data, the sugar content data, the sodium content data and the ED data of the food. In one such embodiment, the healthfulness data is produced by processing SF_data, F_data, S_data, NA_data and ED_data, as follows:

HD=ED_data+[(4×SF_data)+(4×F_data)+S_data+(2×NA_data)]×100/M_serving. (39)

For this group, the most healthful foods have an HD value less than or equal to 3.2, while relatively less healthful foods have an HD value greater that 3.2 and less than or equal to 4.7, even less healthful foods have an HD value greater than 4.7 and less than or equal to 6.6, and the least healthful foods have an HD value greater than 6.6.

In such embodiments, the healthfulness data is determined in a eighteenth, common manner for foods within the following group: fruit, canned. The healthfulness data (HD) for this group is obtained based on the saturated fat content data, the fat content data, the sugar content data, the sodium content data and the ED data of the food. In one such embodiment, the healthfulness data is produced by processing SF_data, F_data, S_data, NA_data and ED_data, as follows:

HD=ED_data+[(2×SF_data)+(2×F_data)+(4×S_data)+(2×NA_data)]×100/M_serving. (40)

For this group, the most healthful foods have an HD value less than or equal to 1.56, while relatively less healthful foods have an HD value greater that 1.56 and less than or equal to 1.93, even less healthful foods have an HD value greater than 1.93 and less than or equal to 3.27, and the least healthful foods have an HD value greater than 3.27.

In such embodiments, the healthfulness data is determined in a nineteenth, common manner for foods within the following group: nuts, nut butters. The healthfulness data (HD) for this group is obtained based on the saturated fat content data, the fat content data, the sugar content data, the sodium content data and the ED data of the food. In one such embodiment, the healthfulness data is produced by processing SF_data, F_data, S_data, NA_data and ED_data, as follows:

HD=(ED_data/3)+[(2×SF_data)+F_data+S_data+NA_data]×100/M_serving. (41)

For this group, none of the foods are graded within the most healthful foods category, while relatively less healthful foods have an HD value less than or equal to 1.5, even less healthful foods have an HD value greater than 1.5 and less than or equal to 5.6, and the least healthful foods have an HD value greater than 5.6.

In such embodiments, the healthfulness data is determined in a twentieth, common manner for foods within the following group: snacks, other. The healthfulness data (HD) for this group is obtained based on the saturated fat content data, the fat content data and the ED data of the food. In one such embodiment, the healthfulness data is produced by processing SF_data, F_data and ED_data, as follows:

HD=ED_data+[SF_data+F_data]×100/M_serving. (42)

For this group, none of the foods are graded within the most healthful foods category or in the relatively less healthful foods category, while even less healthful foods have an HD value less than or equal to 5.491, and the least healthful foods have an HD value greater than 5.491.

In such embodiments, the healthfulness data is determined in a twenty-first, common manner for foods within the following group: snacks—popcorn. The healthfulness data (HD) for this group is obtained based on the saturated fat content data of the food, as well as its fat content data, sugar content data, sodium content data, dietary fiber content data and ED data. In one such embodiment, the healthfulness data is produced by processing SF_data, F_data, S_data, NA_data, DF_data and ED_data, as follows:

HD=ED_data+[(2×S_data)+SF_data+F_data+NA_data−DF_data]×100/M_serving. (43)

For this group, the most healthful foods have an HD value less than or equal to 3.02, while less healthful foods have an HD value greater than 3.02 and less than or equal to 4.0, even less healthful foods have an HD value greater than 4.0 and less than or equal to 6.3 and the most unhealthful foods have an HD value greater than 6.3.

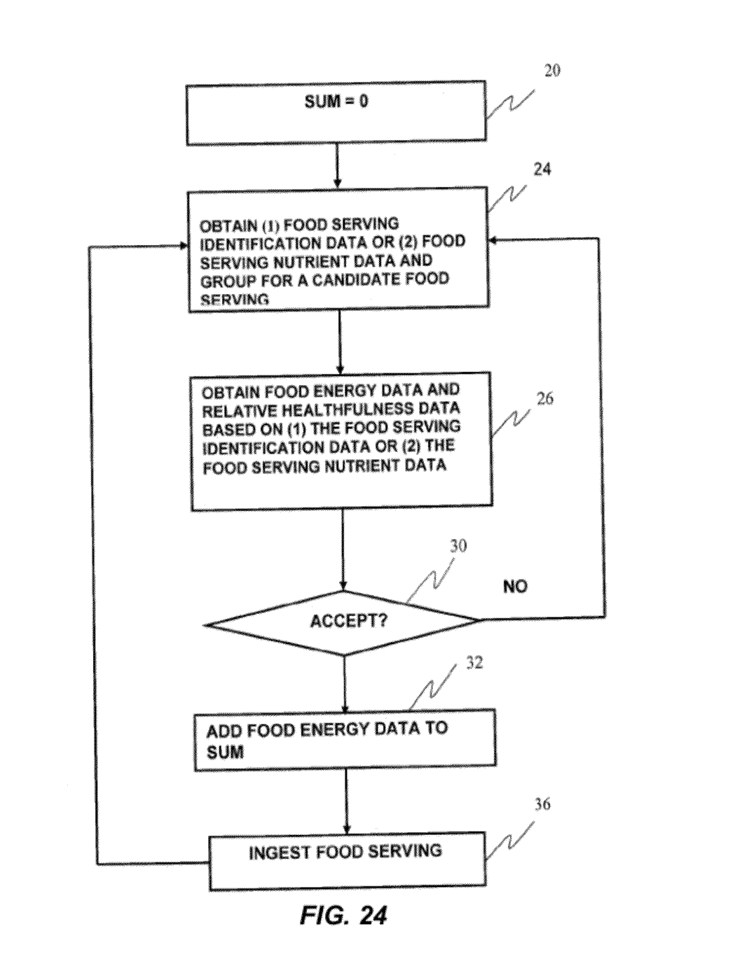

In certain embodiments, methods are provided for selecting and ingesting foods in a way that enables the consumer to control body weight, while simplifying the task of evaluating the relative healthfulness of a candidate food serving. With reference to FIG. 24, at the beginning of a selected period, such as a day or a week, a variable SUM is set 20 to 0. A consumer considers ingesting a candidate food serving and obtains 24 data representing its identity and/or its nutrient content and a pre-determined group including the candidate food serving. In order to evaluate the desirability of ingesting the candidate food serving, the consumer obtains 26 food energy data and relative healthfulness data for the candidate food serving based on at least one of the data representing its (1) identity and (2) its nutrient content and group classification. Such food energy data and relative healthfulness is determined as disclosed hereinabove. In certain advantageous embodiments, such relative healthfulness is represented by distinctly different and suggestive colors and/or shapes on packaging or labeling of a food product, for example: a green star to represent those foods that provided the greatest satiety for minimal kcal as well as a nutritional profile which most closely complements public health guidelines; a blue triangle to represent foods with a nutritional profile that is not as closely aligned with public health recommendations but does have satiety and nutritional virtues; a pink square to represent foods that provide minimal satiety or nutritional value to overall intake but are likely to enhance the tastefulness or convenience of eating; and a white circle to represent foods that, while not making much of a contribution to overall nutrition or feelings of satiety, provide pleasure and can be part of a healthy eating plan when consumed in moderation.

Based on the food energy data and relative healthfulness data thus obtained, the consumer determines whether to accept or reject 30 the candidate food serving for consumption. For example, the consumer may wish to consume a snack food and must decide between a bag of fried corn chips and a bag of popcorn. He or she obtains their relative healthfulness data using one of the processes disclosed hereinabove, and decides 30 to select the popcorn because its healthfulness relative to the fried corn chips is more favorable than that of the fried corn chips. Thus, if the consumer decides 30 to reject a candidate food serving, the process returns to 24 to be repeated when the consumer again considers a candidate food serving for ingestion.

If the consumer has decided that a candidate food serving is sufficiently healthful or selected it in preference to another such candidate food serving, based on the obtained food energy data the consumer decides 30 whether to ingest the candidate food serving or to reject it. If the value of SUM would exceed pre-determined maximum data if the consumer ingests the candidate food serving, the consumer decides 30 to reject it and the process returns to 24 to be repeated when the consumer again considers a candidate food serving for ingestion. If the consumer decides to ingest the candidate food serving, the food energy data is added 32 to SUM, the consumer ingests 36 the candidate food serving and the process returns to 24 to be repeated when the consumer again considers a candidate food serving for ingestion. It will be appreciated that steps 32 and 36 need not be carried out in the order illustrated. It will also be appreciated that the order in which the consumer considers the healthfulness data and the food energy data can vary depending on personal preference.

Where the consumer considers two candidate food servings, and accepts one to be ingested and rejects the other, in effect the process as illustrated in FIG. 24 is carried out twice, once for the candidate food serving accepted by the consumer and again for the rejected candidate food serving.

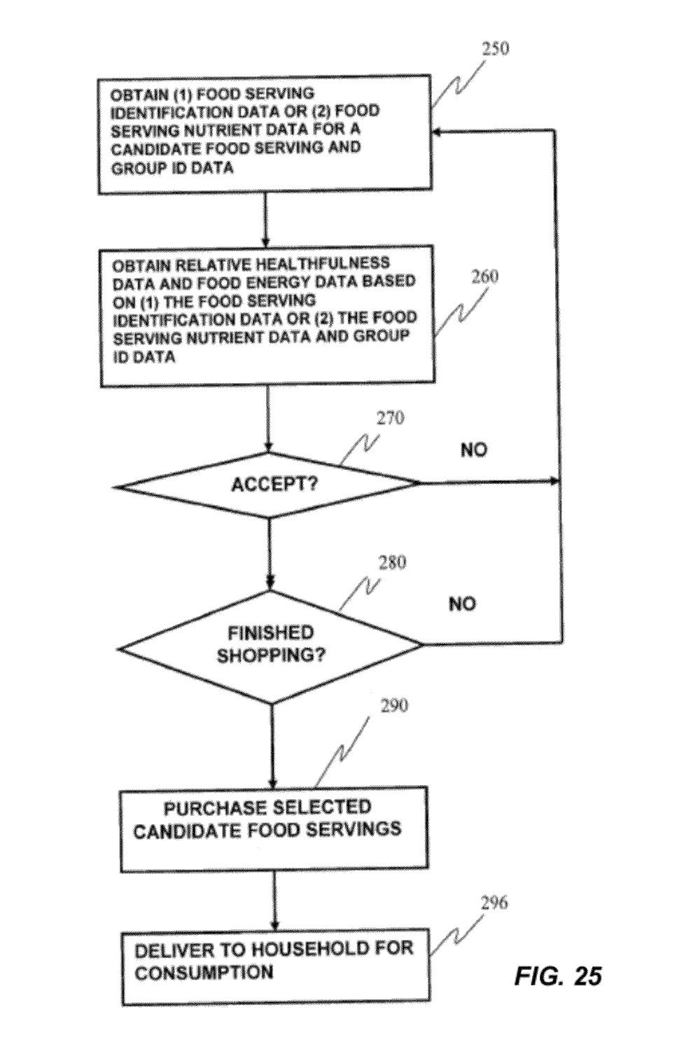

A method of selecting and purchasing food for consumption utilizing the relative healthfulness data and food energy data is illustrated in FIG. 25. When a consumer considers whether to purchase a given food offered for sale, the consumer supplies 250 data representing its identity and/or its nutrient content and a pre-determined group including the food offered for sale. In order to evaluate the desirability of purchasing the food, the consumer obtains 260 relative healthfulness data and food energy data for the food based on at least one of the data representing its (1) identity and (2) its nutrient content and group classification. The food may be a packaged food that display's an image on its packaging representing the relative healthfulness data and food energy data of the product offered for sale. Instead it may be a packaged food that does not display such an image, so that the consumer inputs an identification of the packaged food, or else its classification in a respective pre-determined food group and nutrient content, in a device such as a PDA or cellular telephone to obtain a display of the relative healthfulness data, as disclose more fully hereinbelow. It might also be a food such as produce that is unpackaged and the consumer may obtain the relative healthfulness data and food energy data in the same manner as for the packaged food lacking the image representing same.

Based on the relative healthfulness data and the food energy data, the consumer determines whether to accept or reject 270 the food for purchase. For example, the consumer may wish to purchase cookies and wishes to decide between two competing brands of the same kind of cookie. The relative healthfulness data and food energy data provide a simple and straightforward means of making this decision.

When the consumer has selected all of the foods to be purchased 280, he or she then purchases the selected foods 290 and delivers or has them delivered 296 to his/her household for consumption.

In some embodiments, the App and/or the programmed computer system of some embodiments of the instant invention is/are configured to produce meal plan data for a person on request. A meal plan for a given person is based on a personal profile of the person and relative healthfulness data and food energy data produced for a variety of foods, either prior to the request for the meal plan data or upon such request. The personal profile includes such data as may be necessary to retrieve or produce a meal plan tailored to the needs and/or desires of the requesting person, and can include data such as the person's weight, height, body fat, gender, age, attitude, physical activity level, weight goals, race, religion, ethnicity, health restrictions and needs, such as diseases and injuries, and consequent dietary restrictions and needs.

In some embodiments, the App and/or the programmed computer system of some embodiments of the instant invention is/are configured to produce a plurality of meal plans each designed to fulfill pre-determined criteria, such as a low-fat diet, a low carbohydrate diet, an ethnically or religiously appropriate diet, or the like. Criteria and methods for producing such diets are, for example, disclosed by US published patent application No. 2004/0171925, published Sep. 2, 2004 in the names of David Kirchoff, et al. US 2004/0171925 is hereby incorporated by reference herein in its entirety.

When the consumer considers whether to ingest a candidate food serving, the person looks at how the graphical indicator has changed in response to particular what-if scenario(s). In some embodiments, the person views an integrated image of the graphical indicator including both a numeral representing an energy value of the food serving and an auxiliary image feature representing a further nutritional quality of the food serving. In certain ones of such embodiments, the further nutritional quality comprises the relative healthfulness of the candidate food serving. Such relative healthfulness may be determined as disclosed in this application, or in another manner. In certain advantageous embodiments, such relative healthfulness is represented by distinctly different and suggestive image colors, shades, shapes, brightness, or textures of the graphical indicator. In certain ones of such embodiments, the further nutritional quality represents a relative heart healthiness of the candidate food serving, while in others it represents sugar content for use by diabetic consumers. In certain ones of such embodiments, the further nutritional quality represents an amount, presence or absence of a particular nutrient or nutrients. For example, body builders may wish to know the amount of protein in a serving of a particular candidate food serving or whether such protein includes all essential amino acids.

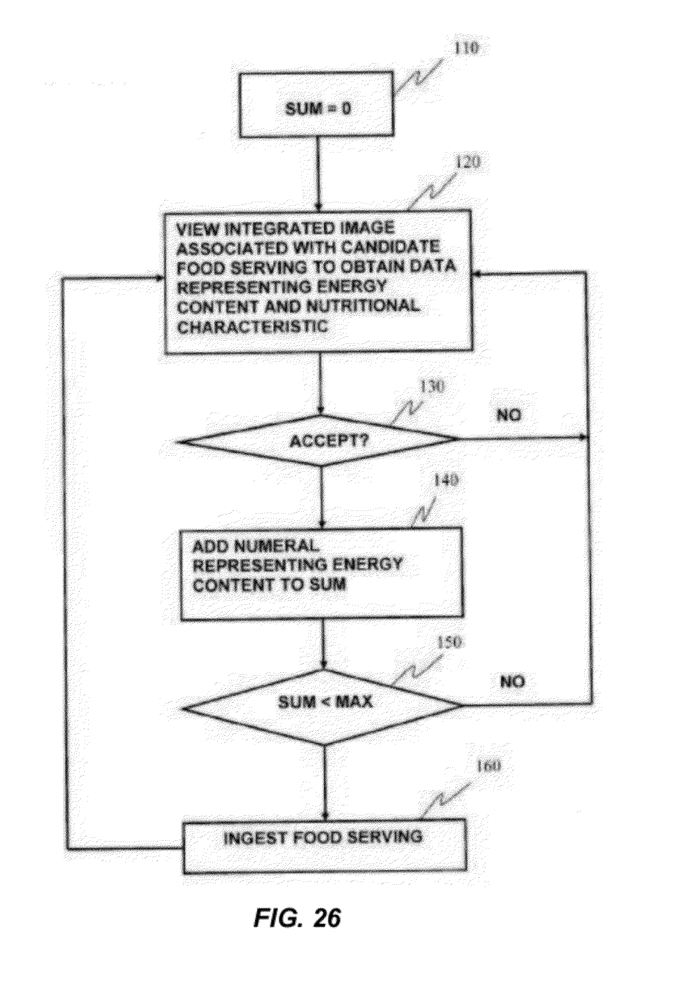

With reference again to FIG. 26, based on the data provided by the integrated image of the graphical indicator, that is, the energy content data and the further nutritional quality data provided thereby, the consumer determines whether to accept or reject 130 the candidate food serving for consumption. For example, the consumer may wish to consume a snack food and must decide between a bag of fried corn chips and a bag of popcorn. He or she views the integrated image on each bag, and decides to consume the popcorn both because its energy content and healthfulness relative to the fried corn chips as revealed by the integrated image are more favorable than those of the fried corn chips. The integrated image thus provides an easily viewed and readily understood evaluation of multiple nutritional qualities of a candidate food serving.

In certain embodiments, with or without the use of a data processing system, the consumer adds the data represented by the numeral in the integrated image associated with the candidate food serving to the SUM 140, and if the SUM is less than a pre-determined daily or weekly maximum MAX 150, the consumer ingests 160 the candidate food serving. In the alternative, the consumer first ingests the candidate food serving and then adds the number data represented by the numeral in the integrated image to SUM. For example, the consumer might not know the precise value of SUM plus the number data, but is aware that it is relatively low compared to MAX.

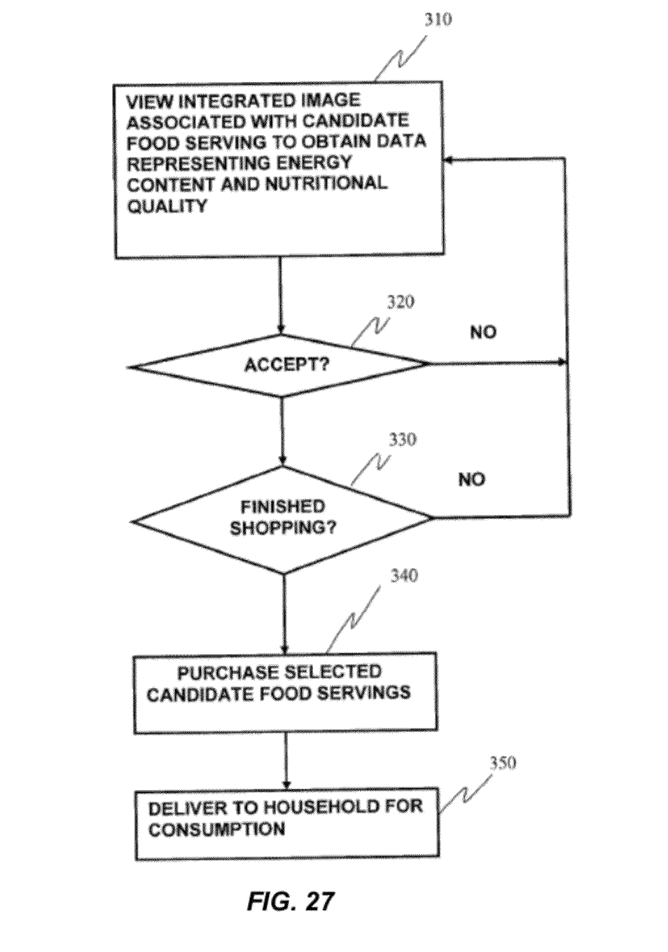

A method of selecting and purchasing food for consumption utilizing the visual tracking of the person's living factor(s) and what-if scenarios as, for example, illustrated in FIG. 27. When a consumer considers whether to purchase a given food for consumption, the consumer views 310 an integrated image associated with the food including both a numeral representing an energy value of the food and an auxiliary image feature representing a further nutritional quality of the food. The food may be a packaged food that displays the integrated image on its packaging. Instead it may be a packaged food that does not display such an image, so that the consumer submits an identification of the packaged food in a device such as a PDA or cellular telephone to obtain a display of the integrated image for evaluation, as disclose above (e.g., scanning QR code, using NFC tag, etc.). It might also be a food such as produce that is unpackaged and the consumer may obtain an associated integrated image in the same manner as for the packaged food lacking the image.

Based on the data provided by the integrated image, that is, the energy content data and the further nutritional quality data provided thereby, the consumer determines whether to accept or reject 320 the food for purchase. For example, the consumer may wish to purchase cookies and wishes to decide between two competing brands of the same kind of cookie. Each may have the same energy content, so that the consumer may wish to choose the brand having a more favorable healthfulness based on differing colors, shapes, textures, shadings or combinations thereof seen in the integrated image on each package. Or else if each has an image having the same auxiliary image feature, the consumer may wish to select the brand having a lower energy content per serving.

When the consumer has selected all of the foods to be purchased 330, he or she then purchases the selected foods 340 and delivers or has them delivered 350 to his/her household for consumption.

In certain ones of such embodiments, the App and/or the programmed computer system of the instant invention is/are configured to store (A) the weighting data and conversion factors necessary to carry out one or more of the processes summarized in equations (1) through (15) hereinabove to produce food energy data, and (B) data identifying the pre-determined food groups and instructions for carrying out the processes necessary to produce the relative healthfulness data as summarized in equations hereinabove.

Examples of Visually Tracking the Actual RCV(t), the Actual RCAV(t), the Potential RCV(t), and/or the Potential RCAV(t) Based on p and/or P_{A}

In some embodiments, the instant invention visually tracks the actual/potential RCV(t) (p) value of food servings consumed and/or contemplated to be consumed by the person. In some embodiments, the instant invention visually tracks actual/potential RCV(t) (p) value of food servings consumed and/or contemplated to be consumed by the person in accordance with, but not limited to, the following equation:

RCV(t)(p)=(p of food serving(1)+p(2)of food serving(2)+ . . . +p(n)of food serving(n)) (44);

where the targeted optimum/desired range/value shown at a particular time is representative of a portion of total (p) attributed to a time from the beginning of the tracking period to the particular time at which the actual/potential RCV(t) (p) value is calculated. For example, if the total (p) is 30, the tracking period is 24 hours, and the actual/potential RCV(t) (p) value is calculated after 8 hours from the start of the tracking period, then the shown targeted optimum/desired range/value is 10-30/(24/8).

In some embodiments, (p) values of the food servings is characterized by the equation (45)

$$p = \frac{c}{{k}_{1}} + \frac{f}{{k}_{2}} - \frac{r}{{k}_{3}} \qquad ( 45 )$$

where c is calories, f is fat in grams and r is dietary fiber in grams for each candidate food serving and where k₁ is about 50, k₂ is about 12 and k₃ is about 5.

In some embodiments, the tracking of the actual/potential RCV(t) (p), as for example shown in the equation (4) is further adjusted based on the person's activity level to determine the actual/potential RCV(t) (p+P_{A}). In some embodiments, the instant invention determines P_{A} on the basis of intensity level and duration of physical exercise. In some embodiments, P_{A}, is a whole number characterized by the equation (46)

$${P}_{A} = \frac{{k}_{4} \times kg body weight \times minutes of activity}{100} \qquad ( 46 )$$

wherein k₄ is a pre-determined numerical weighting factor determined on the basis of intensity level of physical exercise.

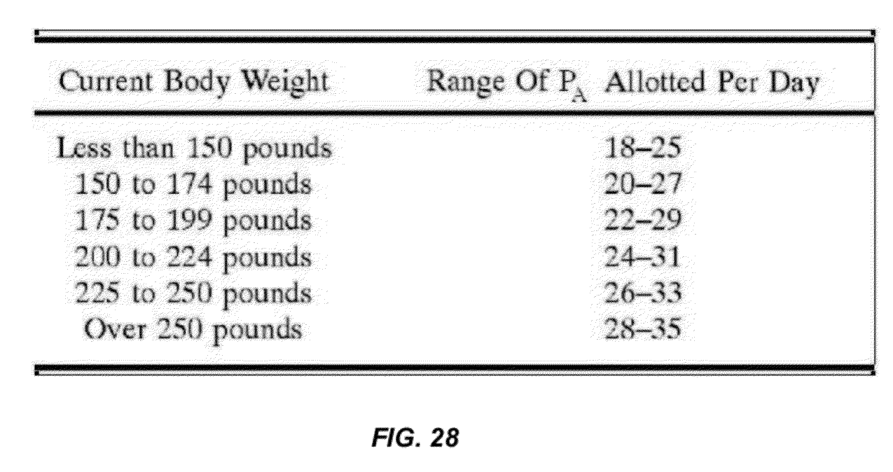

In some embodiments of the claimed invention, a range of P_{A} is allotted per day is determined based on current body weight. In some embodiments, this range of P_{A} can be seven p from minimum to maximum. In some embodiments, the appropriate ranges of P_{A} are assigned to each of series of weight ranges. In some embodiments, when the formula (46) is used with the above-mentioned values of k, the range of P_{A} allotted per day may be determined in accordance with the table shown in FIG. 28.

In some embodiments, k₄ can be between 0.05 and 0.2 and the pre-determined threshold can be 1 to 3 P_{A} per day, for example 2. In some embodiments, the App and/or the programmed computer system of the instant invention is/are configured for calculating P_{A} based on certain metabolic and empirical factors (e.g., intensity of physical activity (e.g., low, moderate or high intensity)). In some embodiments, metabolic and empirical factors can be processed by adding the activities calorie cost to the rest calorie cost for an individual weight (which tends to slightly over estimate additional calorie consumption) and the product is divided by 100 as noted in the following equations (47)-(49).

### Low Intensity:

$$\frac{.051 \times kg body weight \times minutes}{100} rounded off to = {P}_{A} \qquad ( 47 )$$

### Moderate Intensity:

$$\frac{.0711 \times kg body weight \times minutes}{100} rounded off to = {P}_{A} \qquad ( 48 )$$

### High Intensity:

$$\frac{.1783 \times kg body weight \times minutes}{100} rounded off to = {P}_{A} \qquad ( 49 )$$

In some embodiments, the instant invention adds P_{A} to p when P_{A} exceeds a pre-determined threshold of 1 to 3 P_{A} per day. In some embodiments, the instant invention adds P_{A} to p when P_{A} exceeds a pre-determined threshold of 5 P_{A} per day. In some embodiments, the instant invention adds P_{A} to p when P_{A} exceeds a pre-determined threshold of 7 P_{A} per day. In some embodiments, the instant invention adds P_{A} to p when P_{A} exceeds a pre-determined threshold of 10 P_{A} per day.

In some embodiments, the instant invention further incorporates into the visual tracking of one or more calculations based on food energy data (FED) and food healthfulness disclosed in US Pub. 20100055271, US Pub. 20100055652, US Pub. 20100062402, US Pub. 20100055653, US Pub. 20100080875, and US Pub. 20100062119, which are each incorporated herein by reference in their entirety. In some embodiments, the instant invention further incorporates into the visual tracking one or more calculations disclosed in U.S. Pat. No. 6,040,531; U.S. Pat. No. 6,436,036; U.S. Pat. No. 6,663,564; U.S. Pat. No. 6,878,885 and U.S. Pat. No. 7,361,143, each of which is incorporated herein by reference in its entirety. In some embodiments, the instant invention further incorporates the visual tracking one or more calculations based on the calculations disclosed in US Pub. 20100055271, US Pub. 20100055652, US Pub. 20100062402, US Pub. 20100055653, US Pub. 20100080875, US Pub. 20100062119, U.S. Pat. No. 6,040,531; U.S. Pat. No. 6,436,036; U.S. Pat. No. 6,663,564; U.S. Pat. No. 6,878,885 and U.S. Pat. No. 7,361,143.

While a number of embodiments of the present invention have been described, it is understood that these embodiments are illustrative only, and not restrictive, and that many modifications may become apparent to those of ordinary skill in the art.

What is claimed is:

1. A non-therapeutic method for assisting a person to control weight of the person, comprising:
receiving, by a programmed computer system, input data,
wherein the input data comprises at least one of the following categories of data:
i) food data representative of at least one first food consumed by the person, and
ii) what-if food data representative of at least one second food that the person considers to consume;
calculating, in real-time, by the programmed computer system, at least one actual RCV(t) value over a period of time based, at least in part, on the food data of the input data and stored food data, wherein the stored food data is data about one or more food consumed by the person over the period of time prior to the receipt of the input data;
calculating, in real-time, by the programmed computer system, at least one potential RCV(t) value over a period of time based, at least in part, on the what-if food data of the input data and the stored food data;
displaying, in real-time, by the programmed computer system, at least one first graphical indicator representative of the at least one actual RCV(t) value over the period of time,
wherein the displaying of at least one first graphical indicator is indicative of:
i) whether the at least one actual RCV(t) value over the period of time deviates from a visual representation of a pre-determined optimum value or a pre-determined optimum range of values, and
ii) an actual deviation if the at least one actual RCV(t) value over the period of time actually deviates from a visual representation of the pre-determined optimum value or the pre-determined optimum range of values, and
wherein the displaying of at least one first graphical indicator provides information that assists the person to control the weight of the person; and
displaying, in real-time, by the programmed computer system, at least one second graphical indicator representative of the at least one potential RCV(t) value over the period of time,
wherein the displaying of at least one second graphical indicator is indicative of:
i) whether the at least one potential RCV(t) value over the period of time deviates from the visual representation of the pre-determined optimum value or the pre-determined optimum range of values and
ii) a potential deviation if the at least one potential RCV(t) value over the period of time actually deviates from the visual representation of the pre-determined optimum value or the pre-determined optimum range of values, and
wherein the displaying of at least one second graphical indicator provides the information that assists the person to control the weight of the person.

2. The non-therapeutic method of claim 1, wherein the displaying of the at least one first graphical indicator comprises:
positioning the at least one first graphical indicator at a first position along a scale, wherein the first position corresponds to the calculated at least one actual RCV(t) value over the period of time;
wherein the displaying of the at least one second graphical indicator comprises:
positioning the at least one second graphical indicator at a second position along the scale, wherein the second position corresponds to the calculated at least one potential RCV(t) value over the period of time; and
wherein the visual representation of the pre-determined optimum value or the pre-determined optimum range of values is positioned at a third position along the scale.

3. The non-therapeutic method of claim 2, wherein the at least one actual RCV(t) value is at least one actual RCAV(t) value and wherein the at least one potential RCV(t) value is at least one potential RCAV(t) value.

4. The non-therapeutic method of claim 3, wherein the at least one actual RCAV(t) value is calculated based at least in part on energy density of: (i) the food data of the input data and (ii) the stored food data,
wherein the at least one potential RCAV(t) value over the period of time is calculated based at least in part on energy density of: (i) the what-if data of the input data and (ii) the stored food data,
wherein the pre-determined optimum value or the pre-determined optimum range of values are determined from an energy density range of 0.5-1.6 kcal/gram.

5. The non-therapeutic method of claim 4, wherein the at least one actual RCAV(t) value over the period of time is equal to:
(((amount of [kcal]of the at least one first food/100 gram)×weight of the at least one first food)+((amount of [kcal]of Food(2)of the stored food data/100 gram)×weight of consumed Food(2)of the stored food data)+ . . . +((amount of [kcal]of Food(n)of the stored food data/100 gram)×weight of consumed Food(n)of the stored food data))/(weight of the at least one first food+weight of consumed Food (2)of the stored food data+ . . . +weight of consumed Food(n)of the stored food data),
wherein “n” is the total number of Foods of the stored food data;
wherein the at least one first food excludes non-dairy beverages;
wherein the at least one potential RCAV(t) value is equal to:
(((amount of [kcal]of the at least one second food/100 gram)×weight of the at least one second food)+((amount of [kcal]of Food(2)of the stored food data/100 gram)×weight of consumed Food(2)of the stored food data)+ . . . +((amount of [kcal]of Food(n)of the stored food data/100 gram)×weight of consumed Food(n)of the stored food data))/(weight of the at least one second food+weight of consumed Food(2)of the stored food data+ . . . +weight of consumed Food(n)of the stored food data); and
wherein the at least one second food excludes non-dairy beverages.

6. The non-therapeutic method of claim 5, wherein the energy density range is 0.8-1.2 kcal/gram.

7. The non-therapeutic method of claim 5, wherein the energy density range is 1-1.25 kcal/gram

8. The non-therapeutic method of claim 2, wherein the method further comprises:
receiving, by the programmed computer system, weight data of the person, and
displaying, by the programmed computer system, at least one second graphical indicator based at least in part on:
determining, by the programmed computer system, that the person maintains the weight or the person loses weight.

9. The non-therapeutic method of claim 2, wherein a first part of the input data is received from the person and a second part of the input data received from a source other than the person.

10. The non-therapeutic method of claim 9, wherein the source is a remote database.

11. The non-therapeutic method of claim 2, wherein the at least one actual RCV(t) value over the period of time is calculated by:
obtaining weight of protein, PRO(m), for the food data of the input data;
obtaining weight of fat, FAT(m), for the food data of the input data;
obtaining weight of non-dietary fiber carbohydrates, CHO(m), for the food data of the input data;
obtaining weight of dietary fiber, DF(m), for the food data of the input data;
determining a whole number value for the food data of the input data by:
1) determining food energy data for the food data of the input data, FED value, based at least in part on one of:
i) W(PRO)×Cp×PRO(m), wherein W(PRO) is a metabolic efficiency factor of protein and wherein Cp is a energy conversion factor of protein,
ii) W(FAT)×Cf×FAT(m), wherein W(FAT) is a metabolic efficiency factor of fat and wherein Cf is a energy conversion factor of fat,
iii) W(CHO)×Cc×CHO(m), wherein W(CHO) is a metabolic efficiency factor of carbohydrate and wherein Cc is a energy conversion factor of carbohydrate, and
iv) W(DF)×Cdf×DF(m), wherein W(DF) is a metabolic efficiency factor of dietary fiber and wherein Cdf is a energy conversion factor of dietary fiber;
2) dividing the determined FED value by a factor data obtained from a storage device
and saving the result as whole number value for the food data of the input data;
determining a daily whole number benchmark data for the person;
determining the food data of the input data's whole number value;
summing, over the period of time, whole number values of the food data of the input data and the stored food data.

12. The non-therapeutic method of claim 11, wherein W (PRO) is selected from a range 0.7<=W(PRO)<=0.9, W(CHO) is selected from a range 0.9<=W(CHO)<=0.99, W(FAT) is selected from a range 0.9<=W(FAT)<=1.0 and W(DF) is selected from a range 0<=W(DF)<=0.5.

13. The non-therapeutic method of claim 11, wherein W (PRO) is selected from a range 0.75<=W(PRO)<=0.88, W(CHO) is selected from a range 0.92<=W(CHO)<=0.97, W (FAT) is selected from a range 0.95<=W(FAT)<=1.0 and W(DF) is selected from a range 0<=W(DF)<=0.25, wherein PRO(m), CHO(m), FAT(m) and DF(m) are expressed in grams, and wherein Cp is selected as 4 kilocalories/gram, Cc is selected as 4 kilocalories/gram, Cf is selected as 9 kilocalories/gram and Cdf is selected as 4 kilocalories/gram.

14. The non-therapeutic method of claim 11, wherein the factor data is a whole number selected from a range between 20 and 100.

15. The non-therapeutic method of claim 2, wherein the at least one actual RCV(t) value over the period of time is based on:
calculating p value for the food data of the input data by the following equation:
$$p = \frac{c}{{k}_{1}} + \frac{f}{{k}_{2}} - \frac{r}{{k}_{3}} ,$$
wherein c is calories, f is fat in grams and r is dietary fiber in grams for each candidate food serving and where k₁ is about 50, k₂ is about 12 and k₃ is about 5;
calculating P_{A} value for the person by the following equation:
$${P}_{A} = \frac{{k}_{4} \times kg body weight \times minutes of activity}{100} ,$$
wherein k₄ is a pre-determined numerical weighting factor determined on the basis of intensity level of physical exercise; and
adding P_{A} to p when P_{A} exceeds a pre-determined threshold value.

16. The non-therapeutic method of claim 2, wherein the at least one first graphical indicator, the at least one second graphical indicator, the visual representation of the pre-determined optimum value or the pre-determined optimum range of values, and the scale are displayed on a portable computing device of the person.

17. A programmed computing device, comprising:
a non-transient memory having at least one region for storing computer executable program code; and
at least one processor for executing the program code stored in the non-transient memory, wherein the program code comprises:
code to receive input data,
wherein the input data comprises at least one of the following categories of data:
i) food data representative of at least one first food consumed by the person, and
ii) what-if food data representative of at least one second food that the person considers to consume;
code to calculate, in real-time, at least one actual RCV(t) value over a period of time based, at least in part, on the food data of the input data and stored food data, wherein the stored food data is data about one or more food consumed by the person over the period of time prior to the receipt of the input data;
code to calculate, in real-time, at least one potential RCV(t) value over a period of time based, at least in part, on the what-if food data of the input data and the stored food data;
code to display, in real-time, at least one first graphical indicator representative of the at least one actual RCV(t) value over the period of time,
wherein the displaying of at least one first graphical indicator is indicative of:
i) whether the at least one actual RCV(t) value over the period of time deviates from a visual representation of a pre-determined optimum value or a pre-determined optimum range of values, and
ii) an actual deviation if the at least one actual RCV(t) value over the period of time actually deviates from a visual representation of the pre-determined optimum value or the pre-determined optimum range of values, and
wherein the displaying of at least one first graphical indicator provides information that assists the person to control the weight of the person; and
code to display, in real-time, at least one second graphical indicator representative of the at least one potential RCV(t) value over the period of time,
wherein the displaying of at least one second graphical indicator is indicative of:
i) whether the at least one potential RCV(t) value over the period of time deviates from the visual representation of the pre-determined optimum value or the pre-determined optimum range of values and
ii) a potential deviation if the at least one potential RCV(t) value over the period of time actually deviates from the visual representation of the pre-determined optimum value or the pre-determined optimum range of values, and
wherein the displaying of at least one second graphical indicator provides the information that assists the person to control the weight of the person.

18. The programmed computing device of claim 17, wherein the code to display the at least one first graphical indicator comprises:
code to position the at least one first graphical indicator at a first position along a scale, wherein the first position corresponds to the calculated at least one actual RCV(t) value over the period of time;
wherein the code to display the at least one second graphical indicator comprises:
code to position the at least one second graphical indicator at a second position along the scale, wherein the second position corresponds to the calculated at least one potential RCV(t) value over the period of time; and
wherein the visual representation of the pre-determined optimum value or the pre-determined optimum range of values is positioned at a third position along the scale.

19. The programmed computing device of claim 18, wherein the at least one actual RCV(t) value is at least one actual RCAV(t) value and wherein the at least one potential RCV(t) value is at least one potential RCAV(t) value.

20. The programmed computing device of claim 19, wherein the at least one actual RCAV(t) value is calculated based at least in part on energy density of: (i) the food data of the input data and (ii) the stored food data,
wherein the at least one potential RCAV(t) value over the period of time is calculated based at least in part on energy density of: (i) the what-if data of the input data and (ii) the stored food data,
wherein the pre-determined optimum value or the pre-determined optimum range of values are determined from an energy density range of 0.5-1.6 kcal/gram.

21. The programmed computing device of claim 20, wherein the at least one actual RCAV(t) value over the period of time is equal to:
(((amount of [kcal]of the at least one first food/100 gram)×weight of the at least one first food)+((amount of [kcal]of Food(2)of the stored food data/100 gram)×weight of consumed Food(2)of the stored food data)+ . . . +((amount of [kcal]of Food(n)of the stored food data/100 gram)×weight of consumed Food(n)of the stored food data))/(weight of the at least one first food+weight of consumed Food(2)of the stored food data+ . . . +weight of consumed Food(n)of the stored food data),
wherein “n” is the total number of Foods of the stored food data;
wherein the at least one first food excludes non-dairy beverages;
wherein the at least one potential RCAV(t) value is equal to:
(((amount of [kcal]of the at least one second food/100 gram)×weight of the at least one second food)+((amount of [kcal]of Food(2)of the stored food data/100 gram)×weight of consumed Food(2)of the stored food data)+ . . . +((amount of [kcal]of Food(n)of the stored food data/100 gram)×weight of consumed Food(n)of the stored food data))/(weight of the at least one second food+weight of consumed Food(2)of the stored food data+ . . . +weight of consumed Food(n)of the stored food data); and
wherein the at least one second food excludes non-dairy beverages.

22. The programmed computing device of claim 21, wherein the energy density range is 0.8-1.2 kcal/gram.

23. The programmed computing device of claim 21, wherein the energy density range is 1-1.25 kcal/gram

24. The programmed computing device of claim 18, wherein the program code further comprises:
code to receive weight data of the person, and
code to display at least one second graphical indicator based at least in part on:
a determination that the person maintains the weight or the person loses weight.

25. The programmed computing device of claim 18, wherein a first part of the input data is received from the person and a second part of the input data received from a source other than the person.

26. The programmed computing device of claim 25, wherein the source is a remote database.

27. The programmed computing device of claim 18, wherein the code to calculate the at least one actual RCV(t) value over the period of time further comprises:
code to obtain weight of protein, PRO(m), for the food data of the input data;
code to obtain weight of fat, FAT(m), for the food data of the input data;
code to obtain weight of non-dietary fiber carbohydrates, CHO(m), for the food data of the input data;
code to obtain weight of dietary fiber, DF(m), for the food data of the input data;
code to determine a whole number value for the food data of the input data, wherein the whole number value for the food data of the input data is determined by:
1) determining food energy data for the food data of the input data, FED value, based at least in part on one of:
i) W(PRO)×Cp×PRO(m), wherein W(PRO) is a metabolic efficiency factor of protein and wherein Cp is a energy conversion factor of protein,
ii) W(FAT)×Cf×FAT(m), wherein W(FAT) is a metabolic efficiency factor of fat and wherein Cf is a energy conversion factor of fat,
iii) W(CHO)×Cc×CHO(m), wherein W(CHO) is a metabolic efficiency factor of carbohydrate and wherein Cc is a energy conversion factor of carbohydrate, and
iv) W(DF)×Cdf×DF(m), wherein W(DF) is a metabolic efficiency factor of dietary fiber and wherein Cdf is a energy conversion factor of dietary fiber;
2) dividing the determined FED value by a factor data obtained from a storage device
and saving the result as whole number value for the food data of the input data;
code to determine a daily whole number benchmark data for the person;
code to determine the food data of the input data's whole number value;
code to sum, over the period of time, whole number values of the food data of the input data and the stored food data.

28. The programmed computing device of claim 27, wherein W (PRO) is selected from a range 0.7<=W(PRO)<=0.9, W(CHO) is selected from a range 0.9<=W(CHO)<=0.99, W(FAT) is selected from a range 0.9<=W(FAT)<=1.0 and W(DF) is selected from a range 0<=W(DF)<=0.5.

29. The programmed computing device of claim 27, wherein W (PRO) is selected from a range 0.75<=W(PRO)<=0.88, W(CHO) is selected from a range 0.92<=W(CHO)<=0.97, W (FAT) is selected from a range 0.95<=W(FAT)<=1.0 and W(DF) is selected from a range 0<=W(DF)<=0.25, wherein PRO(m), CHO(m), FAT(m) and DF(m) are expressed in grams, and wherein Cp is selected as 4 kilocalories/gram, Cc is selected as 4 kilocalories/gram, Cf is selected as 9 kilocalories/gram and Cdf is selected as 4 kilocalories/gram.

30. The programmed computing device of claim 18, wherein the at least one actual RCV(t) value over the period of time is based on:
calculating p value for the food data of the input data by the following equation:
$$p = \frac{c}{{k}_{1}} + \frac{f}{{k}_{2}} - \frac{r}{{k}_{3}} ,$$
wherein c is calories, f is fat in grams and r is dietary fiber in grams for each candidate food serving and where k₁ is about 50, k₂ is about 12 and k₃ is about 5;
calculating P_{A} value for the person by the following equation:
$${P}_{A} = \frac{{k}_{4} \times kg body weight \times minutes of activity}{100} ,$$
wherein k₄ is a pre-determined numerical weighting factor determined on the basis of intensity level of physical exercise; and
adding P_{A} to p when P_{A} exceeds a pre-determined threshold value.
